(19) United States
(12) Patent Application Publication
(10) Pub. No.: US 2017/0288400 A1
(43) Pub. Date: Oct. 5, 2017

(54) ENERGY PROCESS HANDLING SYSTEM, ASSEMBLY, AND APPARATUS, AND METHOD OF USING OR ASSEMBLING THE SAME

(71) Applicant: DONALD WILLIAMS, THE WOODLANDS, TX (US)

(72) Inventor: DONALD WILLIAMS, THE WOODLANDS, TX (US)

(21) Appl. No.: 15/473,287

(22) Filed: Mar. 29, 2017

Related U.S. Application Data
(60) Provisional application No. 62/314,842, filed on Mar. 29, 2016.

(51) Int. Cl. H02J 3/00; H02J 7/14; F01K 11/02

(52) U.S. Cl. CPC H02J 3/005; F01K 11/02; H02J 7/1415; F02B 63/06

(57) ABSTRACT

An energy process handling system may include energy process handling modules. Each module may be modularly and operationally engaged with at least one other module of the system, such that each module is inter-operationally engaged with the other modules of the system. The system may include at least one system energy process delivery outlet to a localized environment and at least one system energy inlet.

### CROSS-REFERENCE TO RELATED APPLICATIONS

The present application claims the benefit of U.S. Provisional Patent Application No. 62/314,842, filed on Mar. 29, 2016, the entirety of which is incorporated herein by reference for all purposes and made a part of the present disclosure.

### FIELD

The present disclosure relates to an energy process handling apparatus, system, and/or assembly, and more particularly, an energy process handling apparatus, system, and/or assembly for communicating energy to a target localized environment, and a method of using and/or assembling the same, and a corresponding method of communicating energy to a target localized environment.

In one respect, the present disclosure relates generally to an energy process handling apparatus, system or assembly, including a system for, or including, one or more energy transfer or conversion units or modules, a power generation unit(s) or module(s) and/or energy or power distribution unit(s) or module(s). In another respect, the present disclosure relates generally to a multi-unit or multi-module energy process handling apparatus, system or assembly, wherein multiple units or modules receive, transfer, and\or deliver energy from or to at least one other system unit or module, or an environment in which the system is operated or located (e.g., a localized environment). In exemplary systems, each system unit or module converts energy from one form or other, or transfers, enhances, or changes the medium transporting energy. The systems, apparatus, and\or assemblies are particularly suited for localized consumption or delivery, i.e., in or by a discrete, defined space with quantifiable energy demands, such as a building, residence, or mobile enclosure. The present disclosure further relates to both a system and a method of, or for, energy handling, energy management, or energy process handling. The disclosure also relates to a system and method for meeting the energy demand of a localized environment. Furthermore, the present disclosure relates to an energy handling apparatus or system and its assembly, and further, its use or operation. More particularly, the present disclosure relates to a multi-unit energy process handling system, apparatus, and method of using or assembling same, and alternatively, an energy process handing system unit or component for incorporation therewith.

### BACKGROUND

The conventional system of centralized power generation and distribution over a wide geographic network is characterized by vast losses of energy either through thermal loss during production or distribution loss during delivery. It is estimated that only forty percent of the energy generated by such centralized plants in the United States actually make it to the consumer. This grossly inefficient model may be countered somewhat by electric power generating plants that generate power more closely to the consumer and utilizing the thermal energy that is generated as byproduct in electric power generation. In this regard, micro combined heat and power generation systems are available that co generate electricity and heat and utilize the heat on location.

Conventional electric driven air-conditioning systems typically utilize large compressors that are driven by AC inductive motors. These motors demand power for start up and for continuous operation. Reliance on such systems on hot summer days contributes to very high energy demand peaks on the electric grid and inefficiency on the general collective consumption of energy. Internal combustion engines (ICE) can be utilized to drive HVAC compressors directly and the thermal heat generated by the ICE can be used to heat water for domestic use, dehumidify the conditioned air using desiccants, to distill or purify water or to heat swimming pools or Jacuzzis, or in the case of businesses that use boilers, to preheat water for process heat or to generate steam. Small systems that are capable of generating up to 5 KW of electric power and heat simultaneously, and at the same time, provide air conditioning are called Micro Combined Cooling Heating and Power (MCCHP) Systems.

Another application in which cogeneration is found is in Auxiliary Power Units (APU) for commercial long haul trucks. In the United States, these trucks are required by law to rest for ten hours after eleven hours of driving. APUs are designed to eliminate long idle rest stops. Similar to the MCCHP, the APU uses a small internal combustion engine (ICE), typically fueled by diesel, in lieu of the truck's main engine. Since this engine is much smaller than the main engine in terms of displacement, it uses a fraction of the fuel that would be otherwise required to idle the larger engine. These units can run for as much as eight hours on one US gallon of diesel. The engine provides heat to the main engine so that the main engine can be started easily. An APU can save up to 20 gallons of fuel a day, and can extend the useful life of a truck's main engine by around 100,000 miles, avoiding long idle times. APUs provide the truck cab with electrical power for hotel load requirements and may also include air-conditioning for the truck cab. Some APUs even provide an air compressor that maintains the trucks required supply of high pressure air for suspension, brakes and other requirements.

Most conventional energy systems are designed and constructed to serve specific and static applications. This applies in regard to both fuel type and the target application of the fuel. For example, in the modern residence, power to electrical devices may be provided by tapping directly into a communal grid. Heat for cooking, heating water and climate control may be provided by natural gas using a separate energy management system while air cooling may be powered via the grid but using yet another separate system. Typically, such systems are located in different parts of the residence, use different equipment and are managed by different personnel.

It would be desirable to provide energy handling or energy process handling systems that take advantage of the above-described advancements and\or that eliminate some or all of the above mentioned conventional system deficiencies.

### SUMMARY

In one aspect, the present disclosure is directed generally to an energy handling or energy process handling apparatus, system or assembly, including, one or more energy transfer or conversion units or modules, a power generation unit(s) or module(s) and/or energy or power distribution unit(s) or module(s). In exemplary embodiments, the present disclosure describes generally a multi-unit or multi-module (preferably, multi-modular units) energy process handling apparatus, system or assembly, wherein multiple units or modules receive, transfer, and\or deliver energy from or to at least one other system unit or module, or an environment in which the system is operated or located (e.g., a localized environment). For example, such a system may include one or more modular units that receive or deliver energy from\to a localized environment in the form of a residence or other facility (e.g., office building), e.g., engaging in heat transfer therewith and\or delivering (or receiving) power or electricity, or another environment outside of the localized environment (e.g., receiving natural gas\fuel from a distribution source or receiving or delivering electricity from\to the grid). In exemplary systems, each system unit or module converts energy from one form or other, or transfers, enhances, or changes the medium transporting energy. In exemplary installations or applications, systems, apparatus, and\or assemblies are configured or provided for localized consumption or delivery, i.e., in or by a discrete, defined space with quantifiable energy demands, such as a building, residence, or mobile enclosure.

In one aspect, the present disclosure presents an energy (and/or power) handling system and assembly having a first energy process handling component, and a second energy process handling component operationally engaged with the first energy handling component. As used herein, in respect to certain embodiments, “operationally engaged” means the two components share one or more processes, whereby the process or operation of one component impacts the other. For example, in the case of an energy handling module that is, or includes, an energy process handling unit, a product of a process or function of that unit or module (e.g., heat exhaust or electricity) may be received by the other component(s), directly or indirectly. In the case of an energy handling unit, such as a control module, one unit may communicate signals or information to the other unit, and may direct operation thereof. In preferred installations or applications, one energy process handling unit, receives energy from one other module or outside environment, converts received energy into another form or transfers or enhances or changes the medium of energy transport, and\or, then, delivers energy to another module or environment. In further embodiments, the system or assembly includes additional components, wherein each of the components is operationally engaged with at least one other component, and further, wherein each component is directly or indirectly operationally engaged with all other or a plurality of components (e.g., all of the components of the assembly) (sometimes referred to herein, in the context of multi-module system as an “inter-operational relationship of modules.”). In this respect, the assembly of the components is physically and operationally configured as an interconnected or inter-operationally engaged energy handling system. In one preferred installation, a modular system according to the present disclosure consists of modularly and operationally engaged units or modules, and more preferably, interconnected and inter-operationally engaged energy process handling units, that delivers energy to a localized environment or facility.

In another aspect, the energy process handling components are modularly engaged, wherein each component is disposed adjacent and in modular correspondence with at least one other components. Specifically, for purposes of the present disclosure, such a component is said to be modularly and operationally engaged or in modular correspondence with another component or components, when the components are operationally engaged (usually directly), such that processes occurs between the two components or the two components communicate energy between them, and share a face and at least one or two face dimensions (e.g., length\width, height and\or depth). In preferred embodiments, such operational and modular engagement is facilitated by mutually engaged interfaces (which provide the shared faces), the interfaces bearing structural features that readily allow for modular engagement and, disengagement or re-engagement (e.g., registration means and\or a matching flat or contoured faces) and operational engagement, and disengagement or re-engagement (matching ports, flexible and movable communication gear and conduits, etc.).

In yet further and exemplary applications, a system with such modularly and operationally engaged modules is characterized with “variable or flexible operational inter-positionability” also referred to with reference to certain embodiments described herein as “inter-positionability” or “variable or flexible operational inter-positionability”. Such “variable or flexible operational inter-positionability” in multi-module energy process handling systems may be defined by or characterized by individual energy process modules, whose relative juxtaposition may be altered from an initial configuration, defined by the relative arrangement and alignment of modules and the direction(s) of energy process flows defined therein by such arrangement and alignment, to a subsequent configuration defined by the relative arrangement and alignment of modules and the direction(s) of energy process flows defined therein by such subsequent arrangement and alignment. In such systems having variable or flexible operational inter-positionability, the modules are inter-operationally engageable in multiple different arrangements and alignments of the modules. In exemplary embodiments, modules of such systems, characterized by such inter-positionability, may be equipped with multiple interfaces with multiple, strategically-located registration means, communication ports and conduits, and energy transfer ports or conduits.

For purposes of the present disclosures, the terms “components”, “units” or “modules,” may be used interchangeably in the context of an energy handling system or its configuration. Also, several terms may be use to describe mechanical or structural passages defining and facilitating the communication of energy processes or media, including the terms portals, ports or conduits.

The term “operationally” is also used herein interchangeably with “operatively” or “operably.” In the present context, and in the description of energy process handling and energy process handling systems, these terms shall refer to how one system component or unit operates in synchronous with or in response to another system component or unit.

In another aspect, the present disclosure presents a method of assembling or operating a multi-unit energy process handling assembly, such as the aforementioned assemblies or systems.

In one aspect, a method is described for generating and distributing electric power for localized use. The method includes providing a substantially enclosed building or facility having an air conditioning and ventilation unit for supplying cooled air within the building. The unit includes a closed loop circuit configured to operate a closed loop refrigeration cycle, including a compressor operable to compress a working fluid of the closed loop circuit. The method entails engaging an internal combustion engine with the compressor, and operating the internal combustion engine to drive the compressor, thereby transferring energy to the refrigeration cycle (and thus, to the localized environment). The method further includes engaging an electric motor with the compressor; and operating the electric motor to drive the compressor, thereby transferring energy to the refrigeration cycle. To accommodate such service, an energy process handling system, according to the present disclosure, may be equipped with multiple modules including one or more modules containing the engine and\or the generator. The system would be provided with an inlet to receive fuel for the engine and outlets to communicate with the closed loop circuit or compressor, and to communicate electricity (AC and/or DC) to the localized environment.

United States Patent Application Publication US 2015/0033778 A1 is directed to a power generation system and method, and may serve as background for the present disclosure. Moreover, many of the features and aspects described herein may be applicable to and\or incorporated with systems and methods described therein. Accordingly, the entire disclosure of US 2015/0033778 A1, including the claims, is incorporated herein by reference for all purposes and made a part of the present disclosure.

Certain embodiments according to the present disclosure are directed to modularizing energy conversion and management technologies, and\or integrating components, materials and conversion technologies, so as to afford greater mechanical and operational efficiency, emissions control and\or scope of application.

Certain embodiments relate to a system. The system may include multiple modules, including at least a first module coupled to a second module. The modules may be configured such that the modules may be selectively and removably coupled together into different module arrangements. An energy process handling component may be contained within each module. A first energy process handling component may be contained within the first module, and be operationally coupled to a second energy handling component contained within the second module.

Certain embodiments relate to a method of forming an energy process handling system, characterized by modularity and variable or flexible inter-operability. The method may include, initially, mutually engaging (e.g., coupling) multiple modules including at least a first energy process handling module and a second energy process handling module in a first modular and operational arrangement, wherein each module is operationally interconnected with other modules. The method further includes operating the system such that each module handles an energy process, whereby each such module receives and\or delivers energy from or to another of the modules or a localized or outside environment, and whereby the modules define an energy process direction(s) between an inlet and an outlet to a localized environment. The method may further include delivering energy to a localized environment. The method then entails reconfiguring the system of modules, adding one or more modules, or subtracting one or more modules, such that the system is defined by a second modular and operational arrangement, and operating the system, whereby the energy process direction is altered from the first modular and operational arrangement, including changes in direction and\or extension or reduction of process length.

Certain embodiments relate to a system installation that includes an energy process handling system installed at a facility, and including an outlet for delivering energy to the facility and a plurality of modularly and operationally engaged energy process handling units, including a power generating unit and\or heat transfer\exchange units and\or an energy storage units.

Certain embodiments relate to a module for use in module energy systems. The module may include a frame, one or more side panels coupled to the frame, and an internal cavity defined at least partially by the frame. An energy process handling component may be contained within the internal cavity. The module may be adapted to selectively and removably couple with adjacent modules in different module arrangements.

Certain embodiments relate to an energy process handling system that includes energy process handling modules. Each module may be modularly and operationally engaged with at least one other of said modules; such that each module may be inter-operationally engaged with each of said other modules. The system may include at least one system energy process delivery outlet to a localized environment, and at least one system energy inlet.

Certain embodiments relate to a method of operating a modular energy process handling system. The method may include modularly and operationally engaging at least three energy process handling modules in a first modular arrangement. Each said module may be detachably engaged with at least one other of said modules. Each module may support an energy process handling component. An interface panel of each module may be disposed in mutual correspondence with a corresponding interface panel of a modularly and operationally engaged adjacent module. The method may include operating the modular energy system such that said modules accommodate a transfer of energy between said modules. Energy may be directed between modularly and operationally engaged modules through mutually corresponding interface panels. The method may include detaching one of said modules from adjacent modules and re-positioning said modules in mutual modular engagement to form a second modular arrangement. In the second module arrangement, each module may support an energy process handling component and an interface panel thereof may be disposed in mutual correspondence with a corresponding interface panel of a modularly and operationally engaged adjacent module. The method may include operating the modular energy process handling system such that said modules accommodate a transfer of energy between said modules. Energy may be directed between modularly and operationally engaged modules through mutually corresponding interface panels.

Certain embodiments relate to a method of assembling a modular energy process handling system. The method may include modularly and operationally engaging at least three energy process handling modules in a first modular arrangement, where each said module is detachably engaged with at least one other modules, and whereby each module supports an energy process handling component and disposes an interface panel in mutual correspondence with a corresponding interface panel of a modularly and operationally engaged adjacent module. The modular energy system may be operable to accommodate a transfer of energy between modularly and operationally engaged modules through mutually corresponding interface panels. The method may include detaching one of said modules from modular and operational engagement with at least one adjacent modules, and re-positioning said modules in mutual modular and operational engagement to form a second modular arrangement. In the second modular engagement, each module supports an energy process handling component and disposes an interface panel in mutual correspondence with a corresponding interface panel of a modularly and operationally engaged adjacent module. The modular energy process handling system may be operable to accommodate a transfer of energy between modularly and operationally engaged modules through mutually corresponding interface panels.

Certain embodiments relate to a system installation. The system installation may include an energy process handling system including multiple modules, including at least a first energy process handling module modularly and operationally engaged with a second energy process handling module. The modules may be configured such that the modules may be removably coupled together into at least modular arrangements including a first arrangement of modules that accommodate an energy transfer process characterized by at least one process direction, and second arrangement of modules that accommodate the same energy transfer process characterized by at least one different energy transfer process direction. The system installation may include a facility defining a localized environment. The energy process handling system may include an energy process outlet in communication with the localized environment and delivering energy from said energy transfer process thereto.

Certain embodiments relate to an energy process handling module for use in energy process handling systems. The module may include a frame, multiple interface panels coupled to the frame, an internal cavity defined at least partially by the frame, and an energy process handling component supported within the internal cavity. A plurality of said interface panels include registers for mating with corresponding registering structure in a corresponding interface panel of a mutually modularly and operationally engageable module, and access portals for supporting energy communications architecture directed from said energy process handling component externally through said access port.

Certain embodiments relate to a method of energy process handling by operation of a multi-unit energy handling system. The method may include providing a modular multi-unit energy handling system including a power generation module, a system thermal module, an energy storage module, and a system control module. The modules may be in mutual modular and operational engagement. The method may include operating the power generating module, such that exhaust heat is produced. At the system thermal module, the method may include receiving the exhaust heat from the power generating module and processing said exhaust heat. The method may include, at the energy storage module, storing energy generated and received from the power generating module. The system control module may be operated to communicate with said modules

Certain embodiments relate to a method of assembling a modular energy process handling system. The method may include modularly and operationally engaging at least two energy process handling modules in a first modular arrangement. Each said module is detachably engaged with at least one other modules, and each module supports an energy process handling component and disposes an interface panel in mutual correspondence with a corresponding interface panel of a modularly and operationally engaged adjacent module. The modular energy system is operable to accommodate a transfer of energy between modularly and operationally engaged modules through mutually corresponding interface panels. The method may include positioning the modules in mutual modular and operational engagement to form a second modular arrangement. The positioning may include attaching an additional module in modular and operational engagement with at least one of the modules of the first module arrangement to form the second modular arrangement. In the second modular arrangement, each module supports an energy process handling component and disposes an interface panel in mutual correspondence with a corresponding interface panel of a modularly and operationally engaged adjacent module, and the modular energy process handling system is operable to accommodate a transfer of energy between modularly and operationally engaged modules through mutually corresponding interface panels.

### BRIEF DESCRIPTION OF DRAWINGS

So that the manner in which the features and advantages of embodiments of the present disclosure may be understood in more detail, a more particular description of the briefly summarized embodiments above may be had by reference to the embodiments which are illustrated in the appended drawings that form a part of this specification. It is to be noted, however, that the drawings illustrate only various exemplary embodiments, and are therefore not to be considered limiting of the scope of this disclosure, as it may include other effective embodiments as well.

FIG. 1A is a simplified schematic of the basic components of a power generation and distribution system according to the present disclosure;

FIG. 1B is a simplified schematic of an exemplary power generation and distribution system installation according to one embodiment of the present disclosure;

FIG. 2 is a simplified schematic of a power generation and distribution system installation according to an alternate embodiment;

FIG. 3 is a simplified flow chart of a process for generating power for localized consumption;

FIG. 4 is a simplified flow chart of yet another alternative process or method for generating power for a localized environment;

FIGS. 5A-5C are exemplary market presentation including slides illustrating exemplary illustrations and exemplary components;

FIG. 6 is a simplified diagram of an alternative refrigeration circuit amenable to incorporation into a system and method of the present disclosure;

FIGS. 7A-7C are simplified illustrations of exemplary energy process handling systems having multiple units, and their assembly, according to the present disclosure;

FIGS. 8A-8D are perspective views of exemplary energy process handling systems having multiple units, and multiple alternate assemblies thereof, according to the present disclosure;

FIG. 9 is a simplified schematic diagram of a multi-unit energy process handling system, according to an embodiment of the present disclosure;

FIG. 10 is a simplified illustration of a multi-unit energy process handling system featuring at least a power generation unit and a heat processing unit disposed in operational engagement with the power generation unit, according to an embodiment of the present disclosure;

FIGS. 11A and 11B are perspective views of exemplary energy process handling systems having multiple units, and multiple alternate assemblies thereof, according to the present disclosure;

FIG. 12 is a perspective view of exemplary energy process handling systems having multiple units, in a stacked and serial assembly mode, according to one embodiment of the present disclosure;

FIG. 13 is a simplified illustration of a multi-unit energy process handling system featuring a solar power panel unit, according to one embodiment of the present disclosure;

FIG. 14 is a simplified illustration of a multi-unit energy process handling system featuring a solar power panel unit, according to one embodiment of the present disclosure;

FIG. 15 is a simplified illustration of a multi-unit energy process handling system installed at a facility in accordance with certain embodiments of the present disclosure; and

FIG. 16 is a simplified illustration of a multi-unit energy process handling system processing energy in accordance with a Rankine cycle, in accordance with certain embodiments of the present disclosure.

### DETAILED DESCRIPTION

Embodiments of the present disclosure will now be described more fully with reference to the accompanying drawings, which illustrate various exemplary embodiments. The disclosed concepts may, however, be embodied in many different forms and should not be construed as being limited by the illustrated embodiments (e.g., system configurations or methods of energy handling or energy process handling) set forth herein. Rather, these embodiments are provided so that this disclosure will be thorough as well as complete and will fully convey the scope to those skilled in the art and modes of practicing the embodiments.

The present disclosure relates to systems and methods including multiple energy process handling units or modules. Such systems described herein are particularly suited as power generation and distribution units or systems, and further, for localized utilization or consumption, including delivery and/or receipt of energy and/or power. Thus, to illustrate aspects of the system and method, certain embodiments or applications are described that include such systems or methods. Description of these embodiments or applications may be limited to a localized environment largely defined by a residence or commercial building or facility. For example, a “localized environment” may be defined as a discrete space with a quantifiable energy demand, and apply to a residence, building, mobile enclosure or other facility. It will become apparent to one skilled in the relevant engineering, architecture, or other technical art, that these aspects in part, or in their entirety, may be equally applicable to other settings and other applications. Further to this, the present disclosure is directed to multi-unit energy process handling systems and their assembly, as well as to the delivery of energy to localized environments and spaces. Although applications are not so limited, these systems and their assembly are particularly suited for such localized environments.

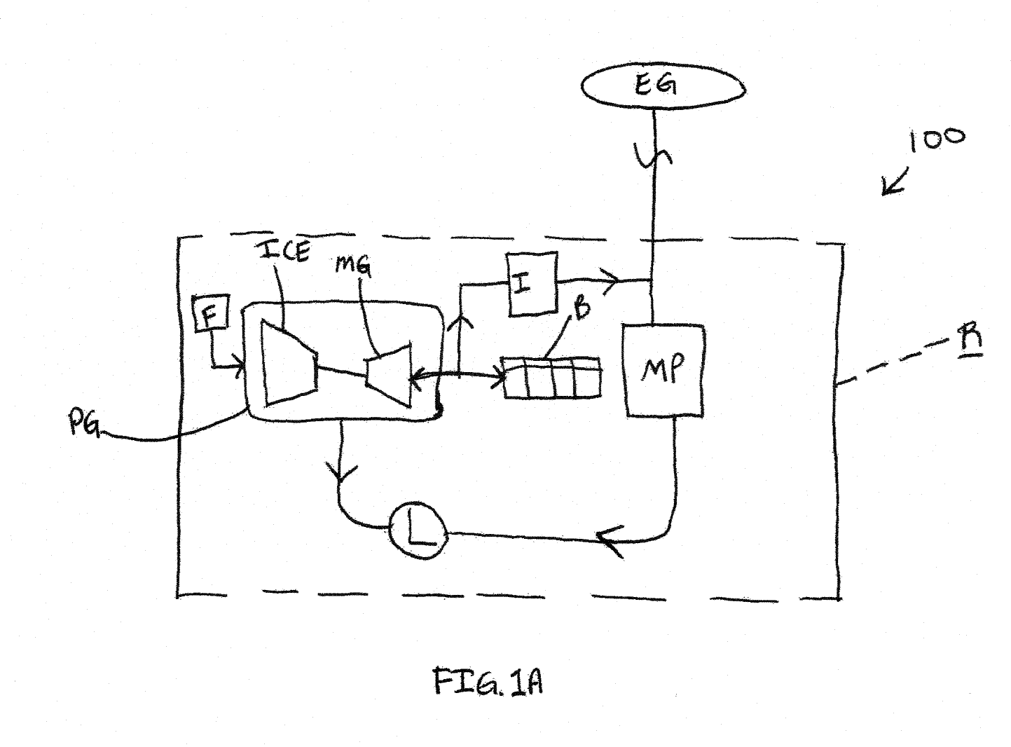

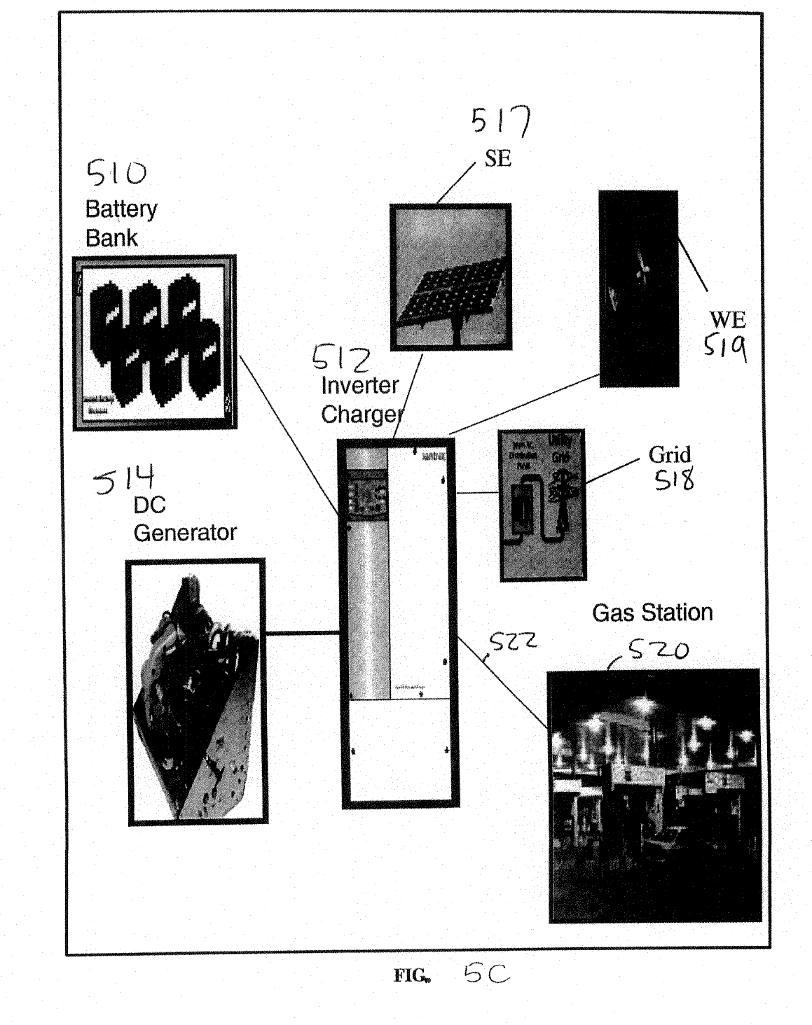

FIGS. 1-6, and accompanying descriptions, appear in an earlier filed, related application and provide some background or introduction to the presently disclosed systems, methods, and assemblies, which are the further described in the appended claims (which are also a part of the present disclosure). Further, FIGS. 1-6 and accompanying descriptions provide an introduction to systems, methods, and assemblies as described later in this Specification, and in or by FIGS. 7A-16. Thus, some of the description that follows, in respect to FIGS. 1-6, are borrowed from that earlier disclosure and may refer to that earlier disclosure (but should not be confused with newly described subject matter first disclosed herein or the priority document).

In further exemplary applications, a system and method according to the disclosure may provide or include a modular electric and internal combustion engine driven HVAC systems suitable for incorporation with an Auxiliary Power Unit (APU), such as that commonly used for idle reduction in class 8 freight trucks. In another exemplary application, such a system and method may be suitable for use in or with a combined cooling, heating, and power system, such as that employed in stationary applications for residential housing or commercial office buildings. Such a system for localized use is often referred to as a Micro Combined Cooling, Heating and Power System or MCCHP system.

FIG. 1A depicts an exemplary system installation 100 for generating and distributing power in a localized environment. The depicted system contains at least some of the basic components of system 100. In this example, the localized environment is provided by a permanent residence (R) (or commercial office building) that is also connected to, and supplied by, the electrical grid (EG). As is typical with such environments, and well suited for the system installation of the disclosure, the residence (R) is characterized by one or more energy demand loads (L), including, for example, air condition cooling demand, electricity demand for ordinary lighting and appliances. In further applications and installations, the localized environment may also exhibit heating demands (as also described herein), for example, for space heating or preheating of hot water systems. It should be noted that when referring to the localized environment, e.g., a residence or a building, in describing the system, installation, or method of operation, components of the localized environment may include equipment, units, or systems not necessarily physically located within the physical boundaries or enclosure of the residence, building, or vehicle (or other localized enclosure or environment). Such auxiliary components or systems may be physically located, partially or entirely, apart from the residence, building, vehicle, and the like, but operationally associated therewith and serving the demands of the localized environment.

To satisfy the requirements of the energy demand loads (L), the residence (R) may draw power from the electrical grid (EG). As known in the art, power is supplied from a low voltage transformer to the AC load panel (MP) of the residence (R), which may include a main panel and distribution panel connecting to the various loads in the physical residence. The exemplary system further includes a power generator (PG) that is operable to meet some or all the demand load (L) of the residence (R), temporarily or permanently in lieu of the electrical grid (EG). In one aspect of the disclosure, the power generator (PG) is a hybrid power generator that includes an internal combustion engine (ICE) as a prime mover and a motor generator (MG), both of which may be engaged to output power (i.e., rotating mechanical energy) for use by the residence (R). In some installations, such a hybrid power generator (PG) is selectively operational in at least a first mechanical drive mode in which the fuel consuming prime mover (ICE) is engaged and a second mechanical drive mode in which the DC motor generator (MG) is engaged. Such selective drive capability may be embodied in a drive assembly (DA) that is engageable with each of the engine (ICE), motor generator unit (MG) and the load (L).

In this installation, a fuel supply (F) such as natural gas, diesel, or propane may be supplied to the system installation 100 for consumption by the power generator (PG). In a further aspect, the power generator (PG) may also be operable in a drive mode in which the internal combustion engine (ICE) also drives the motor generator to generate DC power. This DC output may be directed for storage by a battery bank (B) or to an inverter (I) for conversion to AC power. The AC power may, in turn, be directed to the main panel (MP) for use in the residence or in particular applications, to the electrical grid (EG) for distribution.

Thus, in one respect, the system installation 100 provides for a localized environment access to an energy source independent from the electrical grid. This energy source originates from fuel supplied to an internal combustion. Chemical energy is converted to mechanical energy that is then utilized in meeting a load requirement of the localized environment. Alternatively, the mechanical energy may be used to generate DC power to satisfy immediate load demands of the localized environment, or to store in the battery bank. In the latter case, the energy stored may be used later to drive the engine (and generate energy for meeting the demand load).

In further installations, heat energy generated by operation of the power generator (PG) (i.e., from chemical reactions or mechanical processes within the engine) may also be transferred to the residence (R) to satisfy, at least partly, the energy demands of another load (L). For example, heat exhausted by the engine may be used to heat or preheat water in the HVAC system, pool water, or a water heater, or heat air used for space heating.

Referring now to FIG. 1B, an exemplary system installation 200 for a localized environment is shown servicing a house or residential unit (R). The system 200 may integrate a hybrid power generator with the energy demand loads of the residence, which may include a heating, ventilation, and air conditioning system (HVAC) as commonly utilized in these installation. The HVAC system features a compressor 4 compressing a refrigerant or working fluid. The installation also includes a low voltage household circuit for supplying electricity to household appliances and equipment, outlets, and lighting. The household circuit includes a main panel to which utility power from the electrical grid 13 is supplied, as generally known in the industry. In operational mode, the power generator drives the compressor 4 to increase refrigerant vapor pressure. For example, in the case of a common centrifugal compressor, the power generator drives the main shaft (and impeller) of the compressor.

In yet another aspect of the disclosure, the hybrid power generator employs two power sources each of which may be selectively engaged with the compressor 4. In this example, the power sources are an internal combustion engine 1 and a motor generator 3. The internal combustion engine 1 may be pad mounted and situated adjacent the outside of the house. The engine may be one of various designs that are commercially available. In certain embodiments, the engine 1 is a natural gas or propane engine. One suitable internal combustion engine is natural gas engine from Kubota (Kubuta DG972), which is rated at 25 (power output). The power generator may be equipped with a drive assembly including an engine clutch 2 and belt drive 6 that operationally engages the engine 1 with the compressor 4, when a compressor clutch 5 is engaged. The drive assembly, specifically engine clutch 2, can also engage engine 1 directly with the motor generator unit 3.

In this installation, the motor generator is a DC high capacity started/generator such as ECycle. The motor generator 3 is connected with a DC regulator 8 and thus, a DC power supply. As shown in FIG. 1B, the installation further includes a DC bus 9 that serves both an inverter charger 12 and a battery bank 11, as well as providing an auxiliary DC power outlet 10 for other residential usage. The inverter charger 12 connects with the electrical power supply (i.e., electrical power grid 13) to deliver excess AC power to the grid or bring AC power to the DC bus for distribution. In further applications, renewable electricity generators (e.g., solar panels or wind turbines) may be integrated with the installation to deliver additional energy supply. In such cases, the inverter 12 may be utilized for receiving and converting the additional electricity source.

In a further exemplary system, an electrical control unit or ECU 15 is incorporated as the controller of the system and provides the logic (hardware and software) for activating the engine clutch 2 between the internal combustion engine 1 and the motor generator 3. With proper mutual engagement of the motor generator 3 and engine 1 via engine clutch 2, the ECU 15 initiates rotation of the motor generator 3 to start the internal combustion engine 1. The engine 1 will, according to the settings of its governor, which is also programmed within ECU 15, allow the engine 1 to throttle to a set rpm. At this operational setting, the engine 1 overcomes the motor generator 3. In this mode, the motor generator 3 generates and delivers DC power to the DC regulator 8 and optionally to the battery bank 11 for charging.

As dictated by the demands of the installation, the ECU 15 activates compressor clutch 5 to engage the AC Compressor 4. The hybrid power generator then drives the compressor 4, thereby transferring energy to the HVAC system of the residence. In normal operation, the engine 1 will drive the compressor 4 to compress the working fluid of the HVAC system as required by the appropriate closed loop refrigerant cycle. As determined by the ECU 15 (and as programmed by the user), the engine clutch 2 may simply be disengaged from the motor generator 3. Power provided from battery bank 11 may then be used to run motor generator 3 and thereby, drive the compressor 4. In certain applications, the choice of drive will be done automatically via the electronic control module (to optimize efficiency) or manually (by the operator to comply with noise and emissions regulatory issues). Factors or criteria determining which drive mode to employ include the availability of electrical power from the battery bank or the grid, fuel supply status for the engine for the engine, as well as the demand load presented by the residence. In any event, the ECU 15 may be programmed or configured to receive and/or process input representative of these factors, and determine the various drive modes of the power generator.

While motor generator 3 is engaged and operating as a DC generator, its voltage is regulated to 14, 48 or 56 volts and sent to a DC Bus 9, which in turn, provide powers for DC loads within the installation. Alternatively, it can provide DC power to inverter 12 and provide AC loads to the application or to the electric grid (for a fee or subsidy used by the local utility. A small battery bank 11 may store power and make power available to start the motor generator 3. Further, the battery bank 11 may be utilized to provide a supplemental power needed to accommodate for DC or AC load spikes.

In some applications, the load from the generator is provided as a DC load so as to allow other DC loads from renewable power sources to feed in to the DC bus and share a common Inverter. ECU 15 may be connected with inverter charger 12 to monitor AC current load demand so that it may start the generator 3 in the event that the load so requires. Furthermore, the inverter charger 12 may provide an additional source of DC power to the DC bus, which may then be used to charge the battery bank 11.

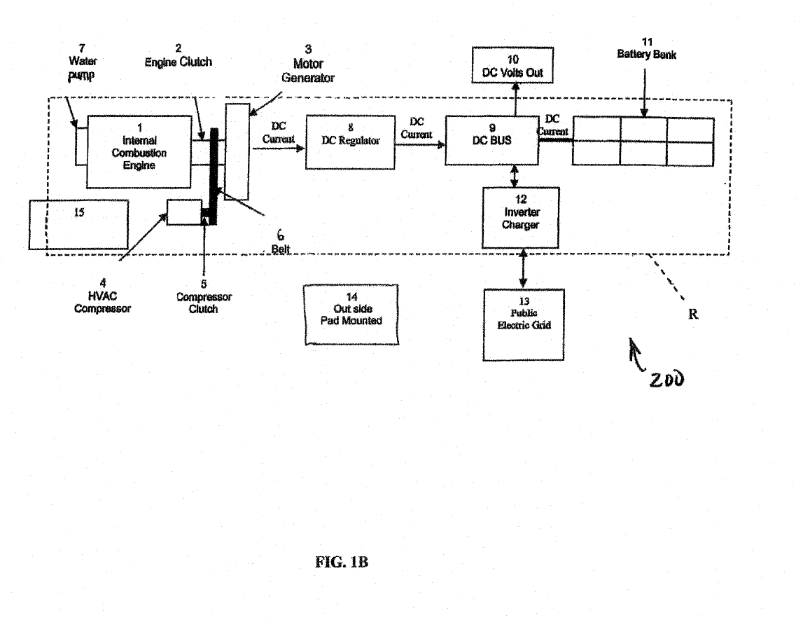

With reference now to FIG. 2, a further and alternative installation according to the disclosure incorporates a closed loop heating circulation system 210. The installation utilizes heat generated in the operation of the engine 1 for satisfying, at least partially, further energy demands of the residence. In the specific installation illustrated, heat generated by the engine 1 is used to preheat or heat furnace water or hot water systems. An exhaust heat exchanger 217 installed and positioned in fluid communication with the exhaust side of the engine's circulation cooling system (as schematically represented in FIG. 2) may be employed to transfer heat generated by the engine. In this embodiment depicted by FIG. 2, a water circulation line 211 is connected with a process dehumidification unit 215 and/or furnace or hot water heater 213. Thus, in a further example, the circulation line 211 passes cool water through coils of the heat exchanger 217, whereby heat is transferred from the engine's circulation to the cooler residential circulation water line. The heat is then passed to the demand for such use as pre-heating the furnace water or water for the water heater 213. To facilitate flow and heat transfer, the circuit 210 also employs a water circulation pump 221 and an engine jacket water expansion tank, as generally known in the art.

In the case of an APU application, the hybrid power generator may be implemented for the purpose of helping the system meet operational restrictions or noise or emissions. By simply engaging the electric motor to drive the ac compressor, using available battery power, the level of noise or emissions normally generated would be reduced (from that generated by internal combustion engine or other auxiliary power generator commonly employed by commercial long haul trucks.

Exemplary Component Descriptions

The descriptions below are provided to illustrate the types or specifications for various components suitable for incorporation into one or more embodiments of the system (operation of these exemplary systems). The component descriptions are provided for illustration only, and shall not be construed as limiting the disclosure and its concepts.

Internal combustion engine: Prime mover for the generator and/or the HVAC compressor, may be a KUBOTA Engine or similar.

Motor/generator: provide power to start Internal combustion engine and/or the compressor or other equipment. This unit may also act as a generator when overcome by the engine, may be an ECycle brushless motor.

Inverter/charger: This unit converts DC power to AC and may incorporates power islanding features, charging capabilities, power monitoring capabilities and automatic transfer switch. Suitable models include the XANTREX or Schneider model 60048 On Grid and Off Grid Inverter.

Battery bank: May be AGM, Deep Cell or another battery capable of producing as much as 100 ah or more at 48 volts or 200 ah or more at 24 volts or 400 amp hours or more at 12 volts. Most battery types available in the market are suitable, including those suitable for golf cart or marine applications.

DC Regulator: capable of regulating the output voltage of the DC motor to 48, 24 or 12 volts, may be manufactured by America Power Systems Inc.

Engine clutch: magnetic clutch similar to those used in vehicular HVAC compressor systems.

Compressor clutch: magnetic clutch similar to those used in vehicular HVAC compressor systems.

ECU: capable of multiple analog and digital Inputs and Outputs similar to those found on DC generators such as the Deep Sea 4700 series controller.

Exemplary Power Generator Operations

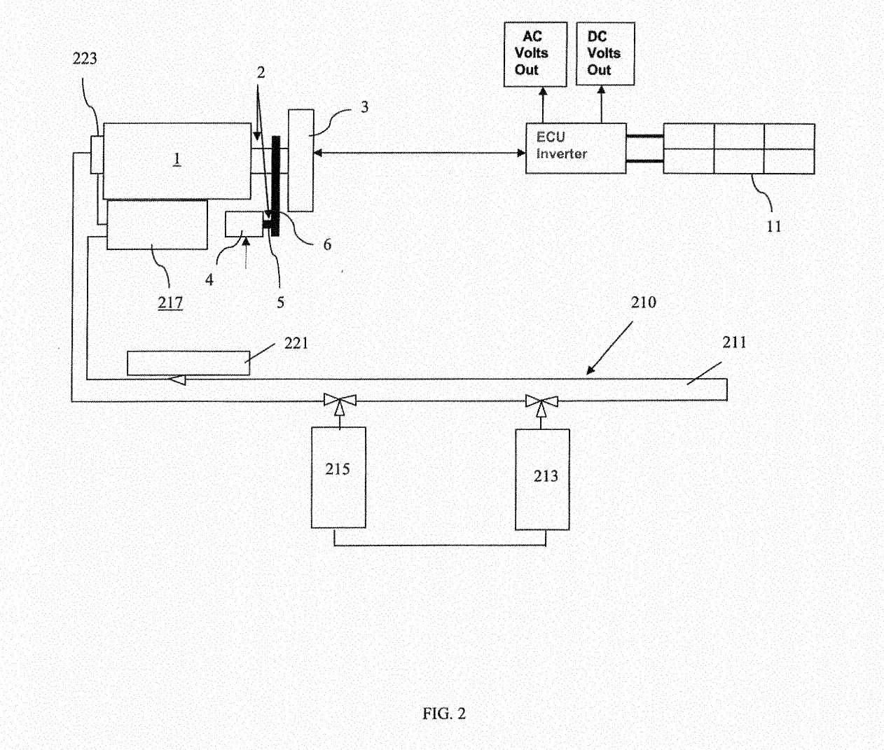

The flow chart of FIG. 3 illustrates steps associated with at least one exemplary method of power generation and/or distribution according to the disclosure. The method is applicable to and associated with a localized environment having demand loads, such as a stationary environment in the form of a residence or commercial office building, or a truck having a main propulsion engine and an APU. The process represented by the flow chart is provided for illustration and to highlight various important capabilities of the system and method.

A method may entail providing such a localized environment having a demand load such as an air conditioning unit. The air conditioning unit includes an AC compressors, as described above. An internal combustion engine is situated in or about the localized environment (52) and may be selectively and/or detachably engageable with the AC compressor to drive the compressor, thereby transferring mechanical energy to the compressor (54). This also transfers energy to the refrigeration cycle operable by or through the air conditioning system, and more specifically, the working fluid of the cycle. In this exemplary method, a DC motor generator is operated to initiate or start the engine. The engine is further driven to a predetermined setting (i.e., set RPM), at which point the motor generator begins to generate DC power (e.g., the motor is overcome by the engine (56)). In further embodiments, the DC power generated may be communicated forward and utilized within the localized environment (e.g., provide a DC power supply to household equipment). In further applications, the DC power may be used to charge a battery bank and alternatively, the battery pack may supply DC power to the motor generator for driving the AC compressor or for initiating start-up of the internal combustion engine. In a further exemplary step, the internal combustion engine may be disengaged from the AC compressor and the motor generator engaged to drive the AC compressor, instead 58. In this mode, the motor generator is driven by DC power supplied by the battery bank.

In one respect, the present disclosure teaches generating power for a localized environment, or more specifically, converting and transferring energy for ultimate consumption by or in the localized environment. In this way, energy is transferred to meet a load (energy) demand of the localized environment. In certain of the embodiments discussed above, chemical energy in the fuel supply is converted to mechanical or rotational energy (in the internal combustion engine). In specific examples, mechanical energy in the engine is used to rotationally drive the compressor, which in turn compresses the working fluid, thereby transferring the mechanical energy to the working fluid and for use in the refrigeration cycle.

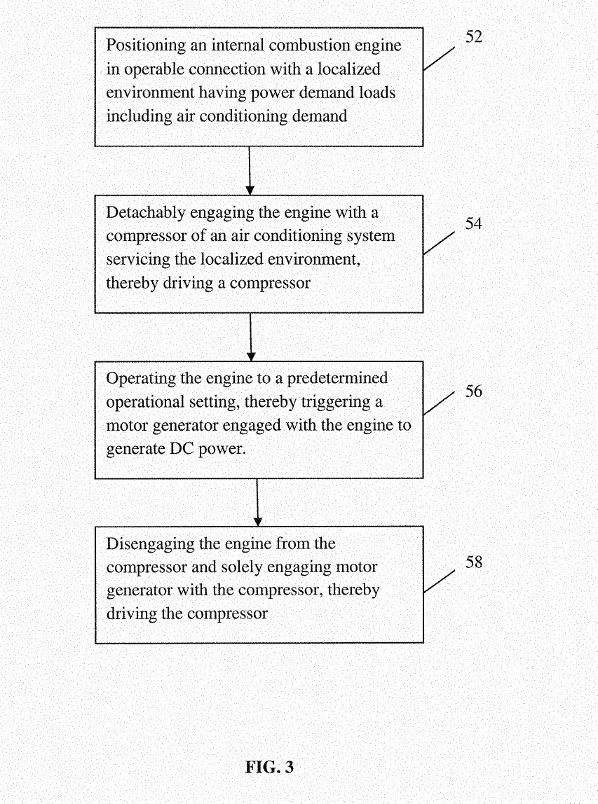

Referring to FIG. 4, a basic process embodied by various applications further involves the utilization of stored energy in the battery bank to turn the motor generator unit (62). Functioning as a starter, the motor generator cranks the internal combustion engine, thereby facilitating its start-up and generating mechanical or rotating energy therein. This mechanical energy is then applied to drive a compressor or other equipment serving the localized environment 64, effectively transferring the generated energy to meet demand load of the localized environment.

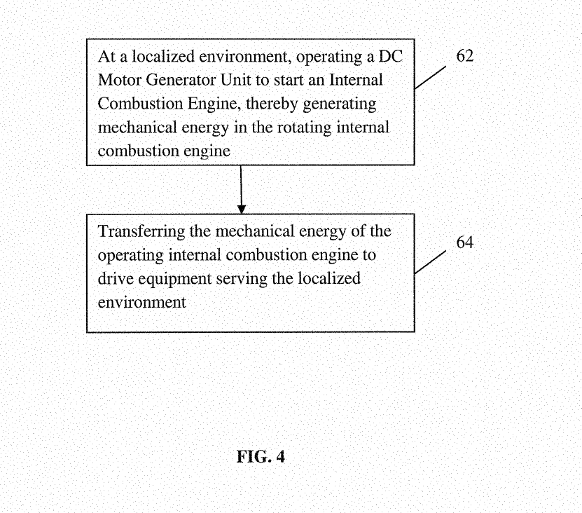

FIGS. 5A-5C illustrate examples of embodiments of the disclosed systems and methods. One exemplary system may have over 3 tons of cooling capacity and 50,000 BTUs of heat, at 75 to 80% efficiency rating. Components of such a system may include an inverter system for providing clean and reliable A/C power and a battery bank for back up power. A suitable inverter commercially available from Xantrex (Elkhart, Ind.). In some designs, the system architecture allows for interconnection with or to renewable power sources (see e.g., FIG. 5C). Energy process handling components suitable for use in certain embodiments of systems disclosed herein include, but are not limited to, a gas engine, an engine oil cooler and lube oil expansion tank, a high capacity starter/generator, a de-super-heater for HVAC condensers, an on-grid and off-grid capable inverter, and an engine 3-way catalyst silencer and exhaust heat exchanger.

FIGS. 5A and 5B illustrate two potential applications of the system and method described above. The first application entails installation at a (localized) gas station 520 and utilizing system heat for providing hot water 524 at a car wash. The second application illustrates system incorporation at (localized) residence 521. The system provides power 522 for normal loads while also providing heat used by the residential space and/or a heating water for the swimming pool. Both systems include inverter charger 512 in electrical communication with a battery bank 510, a DC generator 514, and a grid 518 with a main AC distribution panel 516.

Energy demand at localized environments may peak during at least one time period of a typical day. Certain embodiments of the system may, for example, provide space heating and water heating, while generating electricity for local use. The system may further address and trim such energy demand peaks by meeting air conditioning demands while eliminating or reducing compressor electric motor start peaks. Additional electric peaks may also be managed or accommodated by the battery bank.

Finally, FIG. 5C illustrates the system's integration with renewable energy sources, including solar energy and wind energy. The system of FIG. 5C may provide power to a local gas station while communicating also with the renewable energy sources. The system in FIG. 5C includes inverter charger 512 in electrical communication with battery bank 510, DC generator 514, gas station 520, grid 518, solar panel 517, and wind turbine 519.

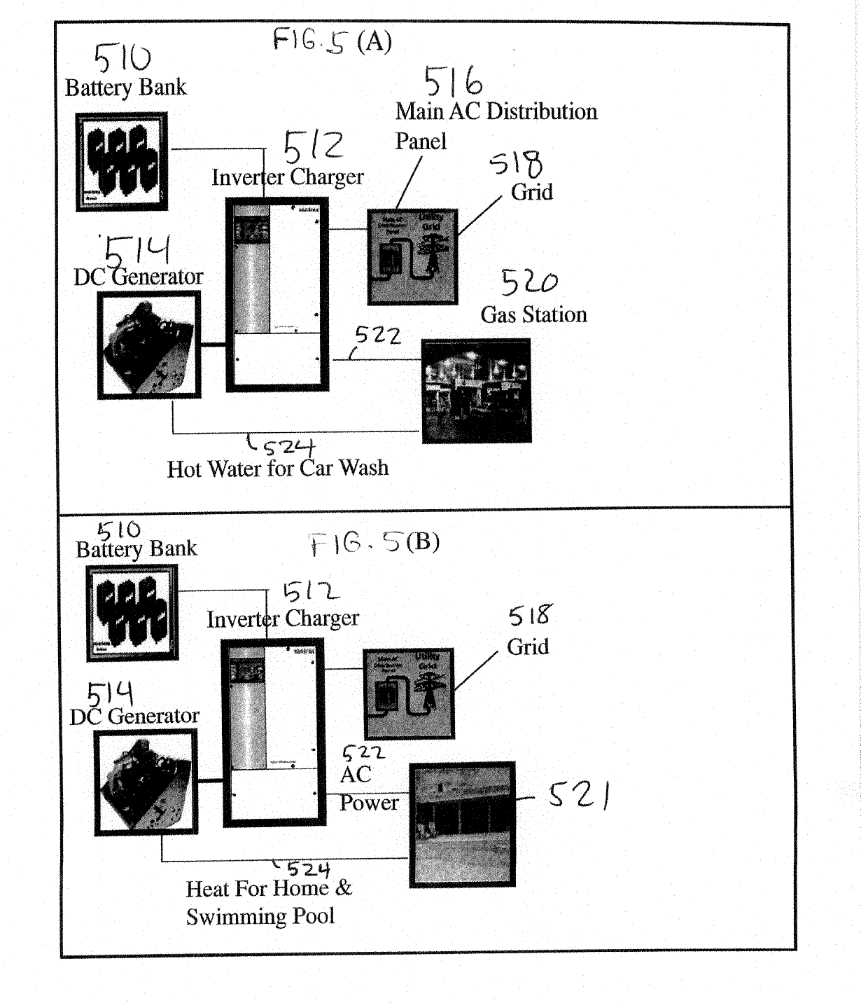

FIG. 6 is a simplified illustration of a refrigeration circuit 600 for incorporation with the systems (and methods) described above and perhaps, those of FIGS. 7-15. The refrigeration circuit 600 (and the refrigeration cycle in which it operates) features a water cooler condenser 606 communicable with a compressor 604 and positioned downstream thereof to receive pressurized vapor from the compressor 604. In the exemplary system depicted, the water cooler condenser 606 discharges into a serial pair of air to refrigerator condensers 608,610. The second condenser 610 then discharges cooler working fluid into a dryer 612 before directing the drier working fluid into an expansion valve 614. The cooled working fluid is then directed to an evaporator 616, where it absorbs heat from the environment before returning the working fluid to the low pressure side of the compressor 604. In the embodiment, the water cooler condenser 606 allows recuperation of as much heat as displaced by the air conditioner and incorporation of the heat to for air drying using a desiccant dehumidifier.

Certain components, methods, and sub-processes described above may be incorporated with or modified to accommodate systems, apparatus, and methods which will now be described in respect to FIGS. 7-16 below. Turning now to FIGS. 7-16, the present disclosure is particularly directed to an energy process handling system including one or more components or units disposed and\or adapted to mutually modularly and\or operationally engage in an advantageous manner. Each component or unit may be referred to as an energy process handling or energy management component, in that it operates to manage, control, generate, transfer, convert, and/or process energy handled by the system or a byproduct or effect of the energy generated or of energy handling processes to which the system is tasked. As discussed above, one aspect of the present disclosure is to provide such an energy process handling system comprising, or even consisting, of energy handling modules that are energy process handling modules. In some embodiments, the system may include energy process handling modules or units interoperable and\or interconnected with other types of energy handling units or modules (e.g., an energy process or energy handling system control module).

In the described and depicted assemblies, the energy process handling units are assembled such that each unit is operationally engaged by another energy process handling unit of the system. This may mean the component engages in furthering a macro or micro process with the other unit, including receiving or transferring energy (as discussed further below). In another aspect, such an energy process handling unit according to the present disclosure is configured for modular incorporation into the energy process handling system and alternatively, for modular incorporation in a plurality of dispositions relative to and in operational engagement with one or more other components of the energy process handling system, as described below.

Accordingly, an exemplary system according to the present disclosure includes an assembly of inter-connected and\or inter-operable components, units or modules each of which is dedicated to a specific fundamental energy management or handling task, and one or more dedicated to advancing a system energy transfer process. Combined in various suitable configurations, the system provides a wide array of energy management solutions, sometimes further referred to herein as modular energy systems (MES). For purposes of description, a system is said to be a modular energy system if composed of energy process handling units each of which is modularly engaged with at least one other energy process handling unit. To this end, FIGS. 7A-7C illustrate such an exemplary system or apparatus mutually integrating at least three such energy process handling units physically disposed and configured to achieve advantageous effect, as described in more detail below. Embodiments of the MES disclosed herein may handle (e.g., convert and/or transfer) one or more forms of energy (e.g., chemical, electrical, thermal, mechanical) and, as explained above, may advance a system energy process (i.e., generate, convert (enhance or alter), and\or transfer energy and\or change energy transport medium). In further descriptions of exemplary systems, apparatus, or methods, an energy process handling system or energy process handling unit or module may be referred to when describing Figures or embodiments, wherein the system, unit or module is, more specifically, an energy process handling system or energy process handling unit or module.

Further, in an embodiment, such modules are constructed of the same materials and, optionally, made to conform to a standard geometry in which dimensions are integer multiples. In this way, multiple beneficial effects are achieved. Inventory control, waste reduction and manufacturing effort may be optimized through sharing of components and fabrication process such as braces, panels, fasteners, tubing and wiring. Standardization in materials and dimensions helps to reduce cost and waste production by reducing wasted space, machining effort, and general complexity. Larger quantities of raw stock may be purchased in bulk, and shipping and packaging efforts are minimized. Standardization and modular construction according to the present disclosure also facilitates storage, transport, installation and servicing due to reliance on a common footprint. The common footprint reduces wasted space and allows direct replacement for servicing or upgrade without disturbing the overall system architecture. A uniform footprint (or face print) also translates to multiple configurations in which modules may be joined side-by-side or stacked vertically. Various permutations and redundant integration then allow for systems or assemblies to easily conform to application specific topologies and energy requirements. In one aspect of the present disclosure, a system may be configured in an initial configuration wherein the units are mutually modularly and operationally engaged, operated to advance an energy transfer process resulting in the delivery of energy to a localized environment, and then, such system units or modules are re-configured in a second configuration, wherein the units are mutually modularly and operationally engaged. The re-configured system is then operated to advance a system energy transfer process resulting in the delivery of energy to the localized environment. In the second configuration, one or more modules may modularly engage different modules or directly modularly engage the same module at a different orientation (i.e., different face(s)).

Although it is apparent that the modules may assume any number of energy process handling tasks including generation, conversion, and storage or control (energy management task), an embodiment may include the following fundamental module configurations: Power Generation Module (PGM) containing the primary source of energy production or conversion; System Thermal Module (STM) disposed to process exhaust heat from the PGM; Energy Storage Module (ESM) containing a medium for energy storage; Energy Transfer Module (ETM) containing hardware and control systems for coupling and\or converting energy formats for exchange between modules or MESs; and System Control Module (SCM) containing the central control unit for managing the MES.

The PGM contains the primary or master form of energy generation for the MES. This may be either directly obtained from a renewable source such as solar, wind, thermal or hydropower, or it may derive it's power secondarily via conversion from an external supply such as fossil fuels, nuclear fuels or hydrogen. Due to its efficient processing, availability and feasibility, an embodiment employs a natural gas engine to convert gas supplied via a communal pipeline to provide electricity, work and heat. Electricity supplied by the engine generator is either ported directly from the PGM for external use or passed to another module such as the ETM or ESM for transfer or storage. Work is provided in the form of an engine powered compressor, which may be used to compress fluids for heat pump operations. Finally, exhaust heat from the engine is passed to the STM for further processing.

The STM manages the thermal aspects of the MES energy profile and may take many forms depending upon the application. Typical tasks include heating and cooling target mediums such as the air in nearby rooms or storage containers to control ambient temperatures and humidity levels, heat and cool water for washing and drinking, general refrigeration as well as even condense and/or vaporize water to produce drinking water from ambient vapor and liquid waste. Energy to perform such thermal processes may be provided from any other module or MES capable of supplying the energy. Due to its ready availability and practicality, an embodiment employs waste heat from the PGM engine as well as including a backup or secondary electrically powered compressor for heat pump operations. The former affords additional energy for powering the above mentioned thermal tasks while also lowering the exhaust gas temperature and increasing the overall MES efficiency. The latter provides a backup drive for the heat pump system, which may be powered from another source of electricity such as the ESM or another MES in the event the PGM is inoperable due to servicing, malfunction or an interruption in fuel source.

Once generated, energy from other sources such as the PGM, ETM or another MES may be stored within the ESM for later use. Here, the storage medium may also take many forms such as electrochemical including rechargeable batteries and supercapacitors, superconducting magnetics, thermal, power to gas or kinetic mediums such as flywheels. Due to their ready availability, reliability, and ease of use, some embodiments employ an array of rechargeable lead-acid batteries.

Aside from generating and storing energy, an MES may also transfer energy within itself from module to module or between one MES and another MES via an ETM. It is noted that while energy transfer and/or conversion may naturally form an innate part of the various processes of many module types such as the energy conversion of the PGM, this is typically secondary to a primary task. However, by definition, this is the ETM's sole primary task. That is, it is designed to convert energy, if necessary, to a compatible format for exchanging energy between modules or MESs at a user defined rate for generic or unspecified use. Typical examples include the use of a thermoacoustic generator, which accepts engine exhaust heat from the PGM and converts the heat to electrical energy for transmission to the ESM or another MES via an electrical conduit. Due to its ready availability and reliability, the ETM of some embodiments employs a bidirectional electrical inverter designed to transfer power between the MES electrical DC voltage bus and an AC powered communal grid system.

In certain embodiments, the SCM is largely a digital control and data acquisition subsystem. Such an SCM communicates with individual modules and/or other MESs and monitor module status in assessing performance and alarm conditions, regulating process control, logging data for future analysis, performing diagnostics and other associated housekeeping tasks. Though data acquisition and communication may take many forms depending on the application, due to its simplicity and robust nature subject to industrial settings, an embodiment employs one or more sub-controllers within each module dedicated to monitoring and/or controlling the module's performance which communicate with each other and a master controller within the SCM via a conventional SCADA network. Finally, though not essential, the SCM may also be equipped with either one or more wired and/or wireless communication interfaces such as USB, Bluetooth or Wi-Fi to allow MES communication with third party systems and software. In certain embodiments, the SCM is not an energy process handling component.

Having summarized at least one basic module construction and operation of an MES, examples of various sample MES configurations may be presented in order to better appreciate the benefits of a modular configuration. Aside from sharing materials and geometries to improve physical efficiencies, modularity also affords enhanced flexibility and adaptability to improve functional efficiencies. As previously noted the modules may be joined side-by-side or stacked vertically to conform to a wide range of energy profiles and application topologies while providing minimal footprint and material expense. Examples include, but are not limited to:
1. Thermal System—This includes an STM, ESM, ETM and SCM designed to provide grid and battery powered backup of a heat pump system.
2. Electrical System—This includes a PGM, ETM and SCM designed to provide electrical energy from both the electrical grid and natural gas supply. An embodiment of the employs a single phase inverter within the ETM. Thus, it may be used as is with a single phase system or combined with two additional electrical systems to produce 3-phase AC power from natural gas.
3. Solar Thermal System—This includes the same modules as the basic thermal system with the exception that the ETM is designed to accept either/or communal electrical grid power or input from an array of solar panels thus producing a solar powered heat pump.
4. Solar Electrical System—This is the same as the basic electrical system except that the ETM contains an inverter for accepting input from an array of solar panels for generating electricity.
5. Dehumidifier System—This may include either a PGM or ETM, STM and SCM. The STM is equipped with a fan and cooling coils using forced convection to remove water vapor from the surrounding air.
6. Water Generation System—This works the same as the dehumidifier system except that the condensed water vapor is stored for later use.
7. Waste Water Purification System—This includes either a PGM or ETM, STM and SCM. Here the STM includes a boiler for vaporizing the waste water and condenser for collecting the water vapor produced. Thus, this system can be used to reclaim water from contaminated sources producing distilled water and solid waste.
8. Synthetic Gas Generation System—This includes a PGM or ETM, STM and SCM. Here, heat is used to liberate CO, CO2 and H2 from hydrocarbon feedstock such as biomass.

It is noted that aside from the mechanical and functional flexibility provided by a modular design, such a system can also provide much higher overall energy efficiencies compared to conventional systems. By incorporating both a PGM and STM, it is possible to synergistically harness greater amounts of useful energy, lower exhaust gas temperatures and thus improve overall efficiencies as compared to that possible with single conversion systems.

Referring to FIGS. 7A-7C, an exemplary, basic module 1100 construction or configuration includes a supporting frame 1110, side panels 1120 (interface panels), fasteners 1130, access portals 1140 and registration pins 1150. The outer face of the side panels including portals and registration means provide an interface for direct modular and operational engagement with a corresponding interface on another module. Said interfaces provide coupling and/or communication architecture for coupling and/or communication between adjacent modules 1100 or between a module 1100 and the external averment or localized environment.

Although many types of frame architecture could be used, certain embodiments employ formed aluminum due to its strength and minimal material use. As previously mentioned in the summary, module dimensions are designed such that they are integer multiples of a base value in order to maximize material use and integration while minimizing storage space and manufacturing effort. Though any base value could be selected, some embodiments may use 17.5″ with a standard module size being a cube of 35″×35″×35″. This equates to a full face of 35″×35″, wherein both a first full face dimension and a second full face dimension are 35″ (linear segment in this case, i.e., length or width). It should be noted, however, that different base values and different full face dimensions are contemplated by the present disclosure (i.e., multiple integers, I, for modularity other than 17:5:17,5 (I=1), 17.5:35 (I=2), and 17.5:42 (I=3) as shown in FIG. 7A), including I=4, 5, or 6. It should be noted as well that in some embodiments, the relevant face dimensions are indicated by perimeter dimensions (i.e., length, width, depth).

Thus, in a three-component assembly, two bottom units or modules 1100a and 1100b are side-by-side, each have a matching first full face dimension and a matching second full face dimension (I=1). An adjacent third unit or module 1100c is disposed above one of the bottom modules 1100b has a ½ face dimension (I=2 between the two units) on the front face physically engaging the bottom unit 1100b on the front face (in the width direction) and a matching full face dimensions in the length or depth direction (I=1). In this assembly, a fourth energy process handling unit, module 1100d, may be provided to the side of the top unit, module 1100c (with the ½ face dimension) and above the two bottom units, modules 1100a and 1100b. In this example, as shown in FIGS. 7B and 7C, the fourth unit, module 1100d, has a face dimension (on the front face and in the length direction) that equals 1½ (I=3) times the full face dimension. The fourth unit, module 1100d, would also have full face dimension in the width or depth direction—matching that of the bottom units, modules 1100a and 1100b, and that of the third unit, module 1100c, beside it (I=1). The energy process handling units in FIGS. 7B and 7C are mutually, modularly engaged, and further, as illustrated below, are also mutually operationally engaged.

Due to its geometrical uniformity, a cubic structure offers variability in module integration. In terms of MES construction, the cubic structure allows individual modules to be rotated and aligned side-by side or linearly or stacked vertically, and serially, and contiguously. The cubic construction also produces a maximum number of possible permutations for arrangement of the modules 1100 and a least amount of non-viable space. To further assist in MES assembly, modules 1100 are equipped with registration structure in interface panels mateable with corresponding registration structure on corresponding interface panels for modular and operational engagement. Registration structure may include registration pins 1150 on one module designed to mate with matching recesses 1140 in neighboring, adjacent modules. The registration pins 1150 assist in alignment during assembly as well as standardized placement of access portals 1140 or partially stamped recesses 1140 or knock outs 1140 in the panel walls 1120 and/or frame 1110. These allow for ready-made application-specific communication architecture (channels) for passing of pipe, conduit, cable and other process handling hardware. Aside from facilitating inter module assembly, the modular approach also facilitates individual fabrication and construction by sharing many of the same elements, components, materials and fabrication processes. Each module 1100 may have an internal space or cavity 1113, which may be at least partially defined by frame 1110, panels 1120, or combinations thereof. Energy handling components, as described herein, may be contained within internal space or cavity 1113. One or more of access portals 1140, partially stamped recesses 1140, and knock outs 1140 may provide access from outside of internal space or cavity 1113 to inside of internal space or cavity 1113. For example, access portals 1140, partially stamped recesses 1140, and/or knock outs 1140 may allow for fluid, electronic, and/or data communication between energy process handling components contained within adjacent modules 1100, and/or mechanical communication between energy process handling components contained within adjacent modules 1100, and/or mechanical communication contained within contained within adjacent modules 1100.

In at least some embodiments, the base or loading platform 1160 does not fully comply with standardization and, in one respect, is not a functional module in the inter-operative sense (i.e., is not operationally engaged with the modules). The raised platform 1160 may be specifically configured to allow for convection, which helps to prevent module ground rot and corrosion. The platform 1160 may also be equipped with portals 1170 to allow ventilation and/or access by forklifts to facilitate positioning. Modules 1100 may be arranged, modularly assembled, and operationally coupled to form modular assembly or system 1180 (MES platform).

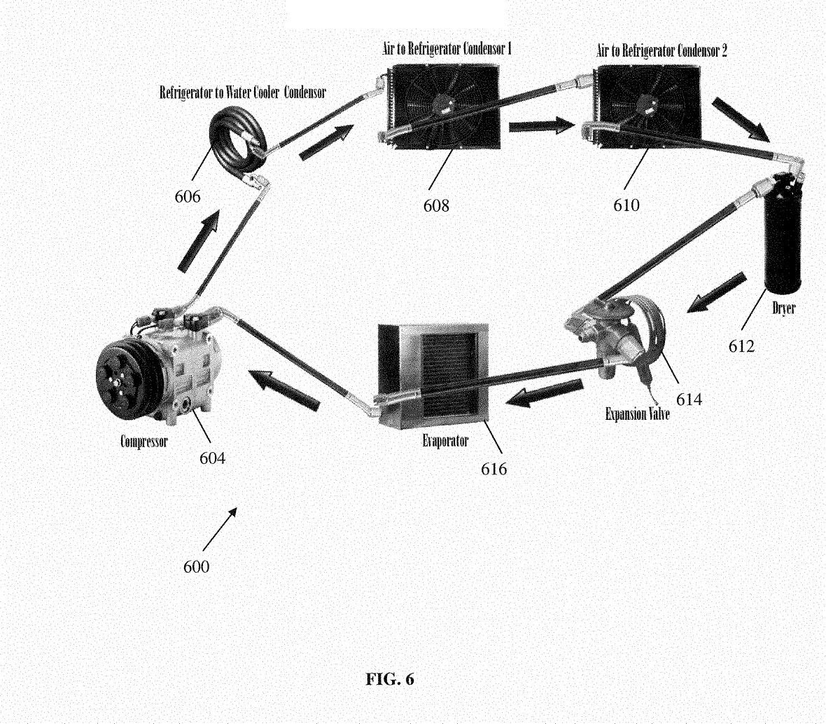

The modules 1100 may also be equipped with energy management hardware to realize the basic energy building blocks. Suitable hardware include, but are not limited to, PGMs, STMs and SCMs, which may be readily integrated in a number of configurations. In this way, a wide array of MES 1180 platforms may be formed from modules 1100 to accommodate various energy solutions from simple lower power, small footprint systems to complex, multifunctional high power applications, each employing the same basic building blocks, modules 1100. To illustrate, FIGS. 8A-8D demonstrate four possible MES architectures of increasing complexity. FIG. 8A shows a simple two-unit system, MES 1180a, containing a PGM 1200, such as a natural gas powered generator, and a control module 1230 (I=1, 2). This system may be used to provide electrical energy from a natural gas supply. FIG. 8B depicts a three-unit energy process handling system, MES 1180b, with three units in modular engagement (I=1, 2). This system adds an ESM 1210 as a third module specifically configured for energy storage (of system generated electricity) and to supply or supplement electricity at pre-determined critical states, i.e. when the PGM is inoperable. FIGS. 8C and 8D show more complex systems, MES 1180c and 1180d, in which an STM 1240 has been added to provide heat pump service using engine exhaust heat from the PGM 1200. Note also the SCM module 1230 and STM module 1240 may be placed either adjacent to the PGM 1200 and ESM 1210 modules (serial connection along the horizontal) as shown in FIG. 8D, or stacked on top of the modules to accommodate applications afforded less floor space.

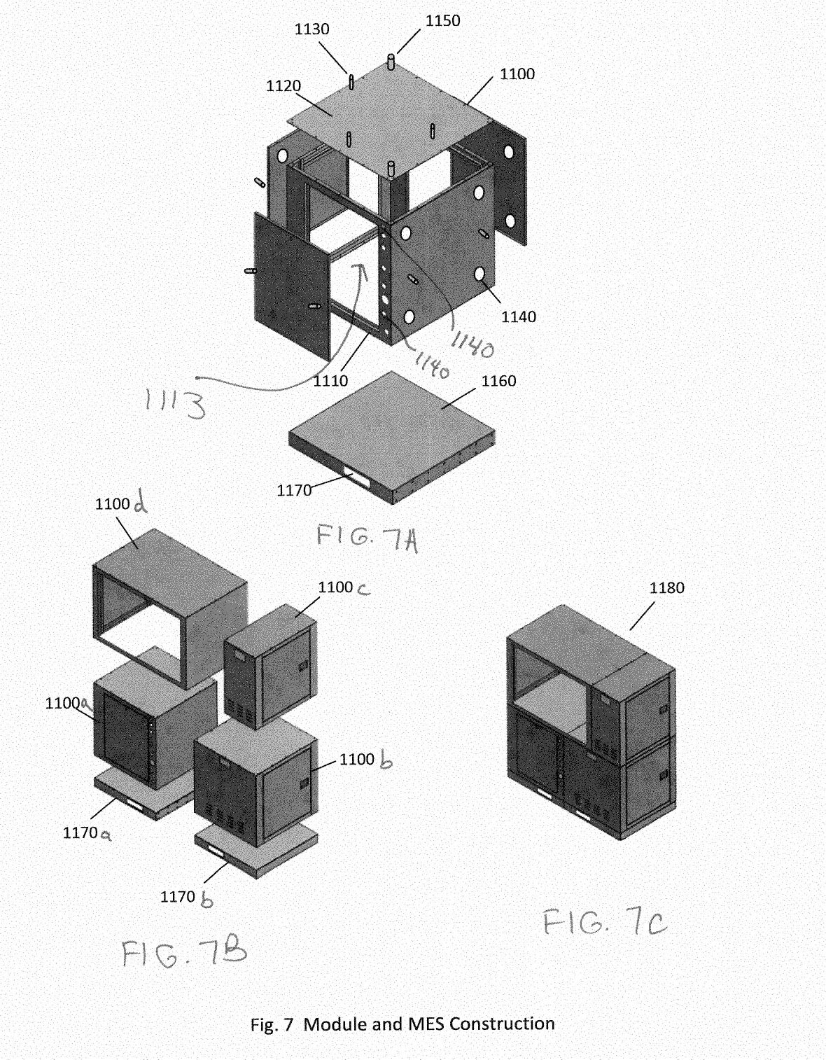

Aside from mechanical integration, the MES achieves multi-module functional or operational integration (operative engagement) aided by inter-module energy process handling and control, communication, and/or coupling architecture (e.g., channels), as well as sufficient and strategic space allocation and unit placement within the module cavities (e.g., provide sufficient space to reroute communication architecture or adjust component positions). This architecture, or specifically, channels or conduits are preferably provided largely by various modular access passages or portals 1140 and flexible conduits or hoses directed thereto. See, for example, the block diagram of FIG. 9. In this embodiment, the energy process handling system or assembly includes a PGM 1200, STM 1240, ESM 1210, and SCM 1230 which are integrated to construct a combined heat and power system. In this exemplary embodiment, the PGM 1200 contains a natural gas engine generator 1320 and module bus communication module 1330, the ESM 1210 is composed of a bank of rechargeable lead acid batteries 1360, the STM 1240 contains a heat exchanger 1300, and the SCM 1230 contains a control system unit 1380 and external communication circuitry 1370. Energy is exchanged with the surrounding environment via natural gas line plumbing adapters 1311 (system inlet), electrical cables 1350 (system outlet) and heat exchanger fluid plumbing adapters or exhaust duct 1312 (system outlet). Here, natural gas 1311 is oxidized resulting in an exothermic reaction producing both heat and electrical energy via induction from the attached generator. The electrical energy is passed through cables 1350 to both the battery array 1360 of the ESM 1210 for storage and an external crossover circuit or switch 1390 which ports either the direct energy from the generator or stored ESM energy to external systems such as a residence utility supply. Heat energy is ported via exhaust plumbing 1312 to the STM 1240 where the exhaust is received by and passed through the heat exchanger 1300. The heat exchanger utilizes a working fluid circulated past and in convective heat transfer with the exhaust heat medium using an external heat pump system. Heat exchanger 1300 may include fan 1301, coils 1303, and plumbing 1310 as generally known in the art. Lastly, MES energy management is controlled via a distributed control system consisting of a series of intra-modular control units 1330, a master control unit 1380 within the SCM 1230 and an interconnecting bus 1340. Although any bus type architecture could be used, in one embodiment a standard SCADA physical layer and protocols is used. The user may employ either a module interface 1381 such as a switch panel, keyboard or touch screen or a remote communication system 1370 such as a serial port, USB port, Bluetooth, Wi-Fi or cellular connection to access and communicate with the master controller 1380 and/or individual module control systems 1330 via the system bus 1340 to regulate power production, direction and storage as well as respond to alarm conditions, perform diagnostic routines and monitor system performance.

In some embodiments, each energy process handling component of the MES disclosed herein may be a component adapted to receive energy in one form (e.g., electrical, chemical, mechanical, thermal) that is output from an external source, such as an electrical grid, a natural gas line, or another energy process handling component. Such a component is said to be equipped with a system inlet. Each energy process handling component of the MES disclosed herein may be a component adapted to process the received energy, and output the processed energy in a different form, in a different medium, or combinations thereof. For example, with reference to FIG. 9, internal combustion engine 1302 may receive chemical energy, natural gas 1311, which is oxidized resulting in an exothermic reaction to produce both thermal energy and electrical energy via induction from the attached generator 1320, thereby converting energy in chemical form to both electrical and thermal form. Also, heat exchanger 1300 may receive thermal energy, heat 1312, from internal combustion engine 1321, and may transfer that thermal energy to another medium contained within plumbing 1310 (e.g., water), thereby transferring energy in the same form but to a different medium. As discussed previously, such energy handling units or modules are, therefore, referred to herein as energy process handling units or modules, and the modular energy handling system is referred to as an energy process handling system.

It is noted that while many conventional systems contain the components connected in a manner similar to that as shown in FIG. 9, they do not incorporate the modular configuration and flexible or variable inter-operability presented herein. Among other issues, conventional systems are constructed as a monolithic whole, without means (e.g., architecture) for facilitating structural and\or operational reconfiguration of the system. This makes it also difficult to accommodate different geometries with the same system, to add or subtract components, to accommodate varied and/or changing energy functionality or scale components, or to accommodate varied energy demands.

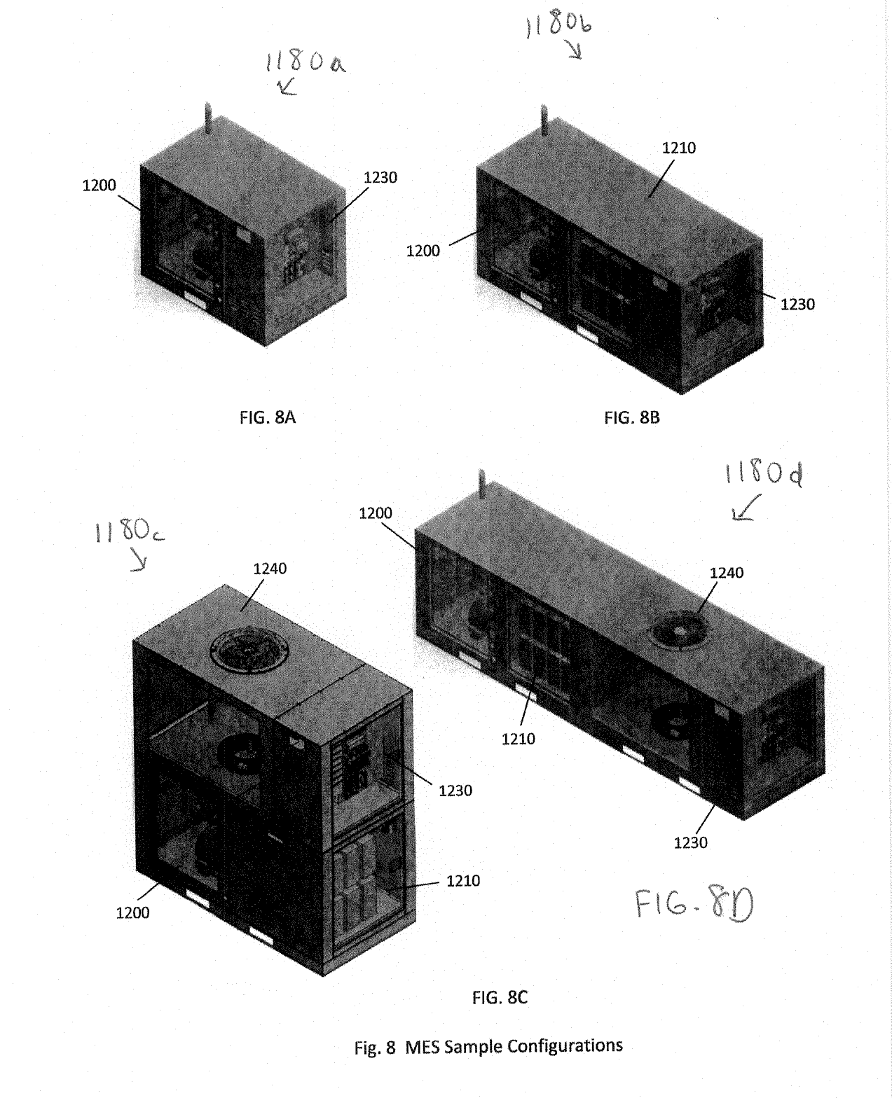

Referring to the simplified diagram of FIG. 10, an exemplary system 1180e is shown assembled, internally, in a number of different configurations. In this embodiment, a PGM 1200 having a natural gas generator 1320 is shown connected to one or more STMs 1240 in different positions by routing engine exhaust 1312, electrical cable 1350 and communication busses 1340 through different module portals 1140 disposed on different interfaces of the PGM module 1200 (for ready modular and operational engagement with a corresponding STM module). As illustrated by FIG. 10, the system and modules, according to the present disclosure, are characterized by variable or flexibly operational inter-positionability, wherein an energy process handling component (e.g., STM) may be positioned in multiple modular juxtaposition and operational engagement with another energy process handling component (PGM). Similarly, the system may be described to be characterized by variable or flexibly operational inter-positionability as illustrated by the four different PGM-STM configuration illustrated in FIG. 10, each of which achieves and advances the same energy process flow but in different directions and with different module alignment or arrangement.

This also illustrates that it is possible to use and dispose different STM 1240 types, for example, placing a heat exchanger 1240 for ambient temperature control to the left side of the PGM 1200 while placing a water distillation unit 1240 on top of the PGM 1200.

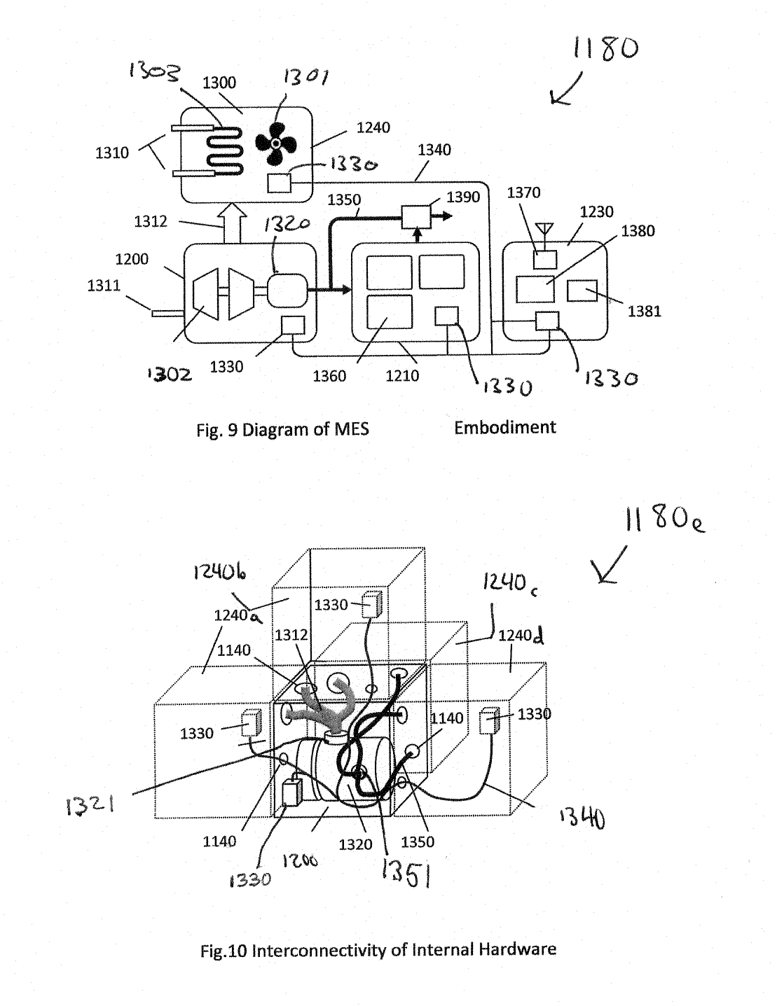

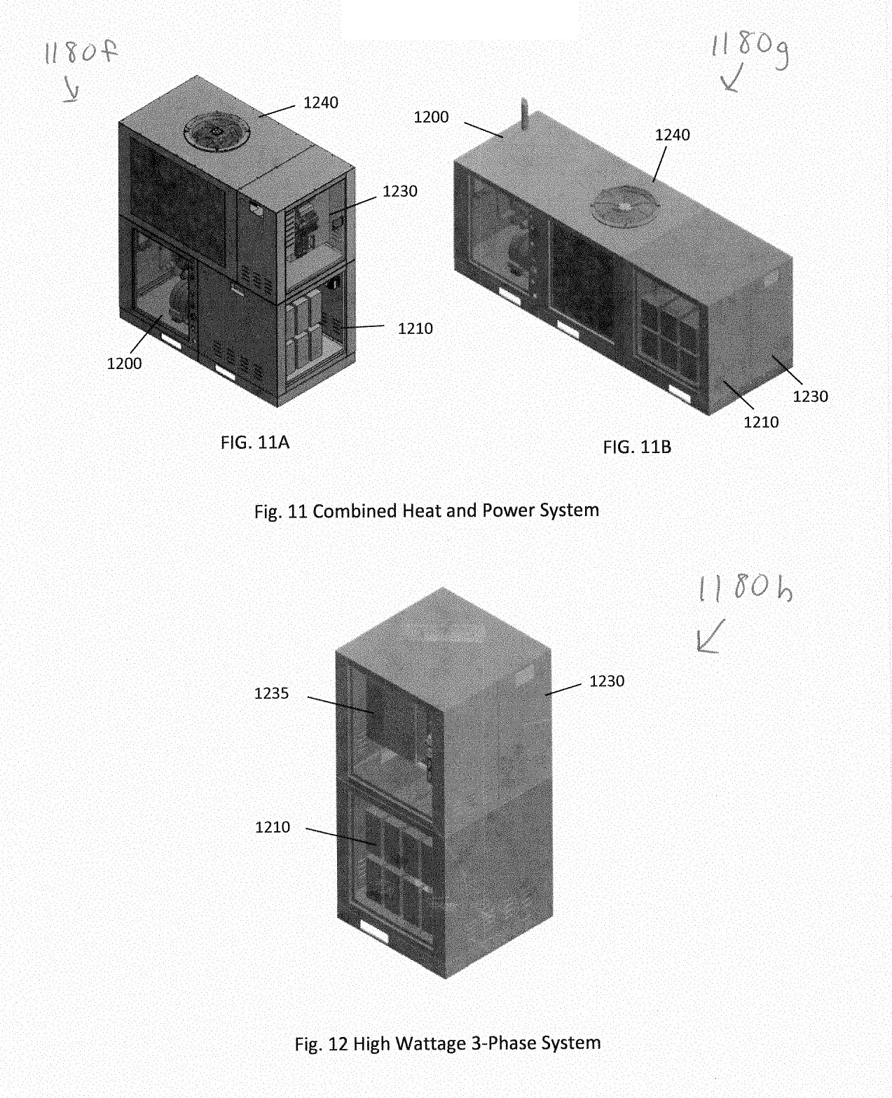

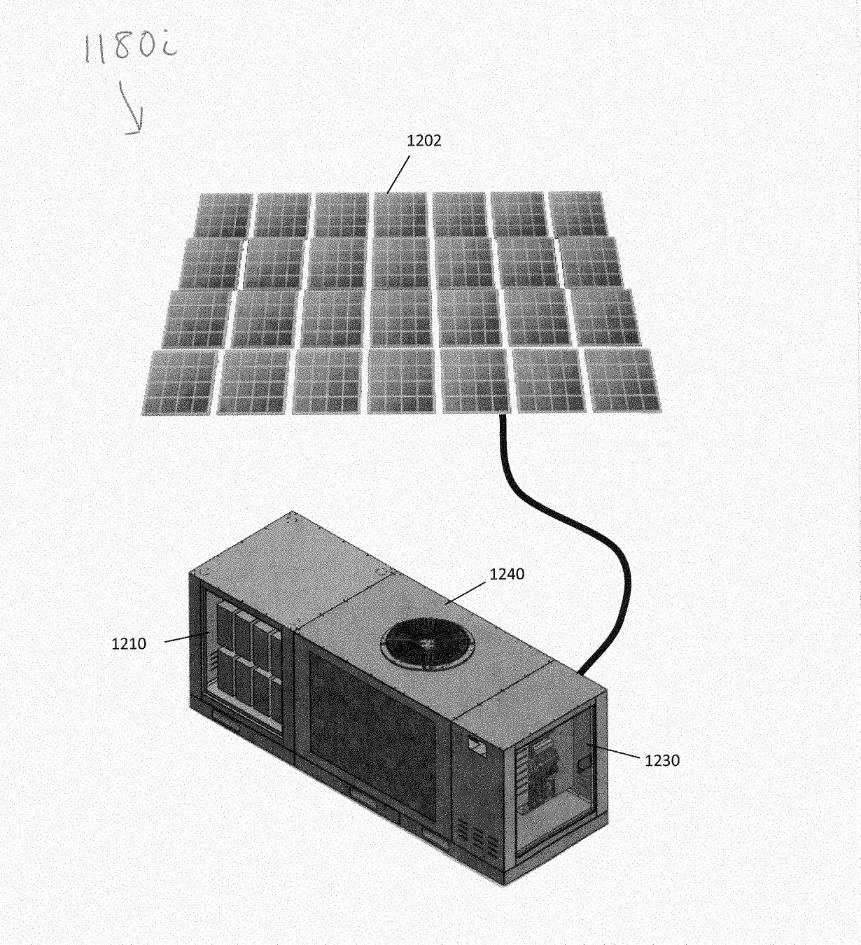

Aside from that presented thus far, many other types of energy solutions can be constructed by introducing new basic modules designed in accordance with the MES schema of the present disclosure. Methods of assemblies are possible to accommodate other functions or new and emerging technologies and energy sources. Such systems characterized by modular construction and flexible or variable inter-operability allows for ready construct and reconfiguration based on new architectures or for supplementing or upgrading existing systems by simple module replacement, re-positioning, and\or annexation. Typical examples include a natural gas based electrical generation system 1200 with furnace 1240, bidirectional inverter 1230 for sourcing and sinking a communal electrical grid system, and battery backup supply 1210 as shown in FIGS. 11A and 11B. FIG. 11A shows a stacked or high profile configuration MES 1180f, and FIG. 11B shows a low profile configuration MES 1180g. It is also possible to combine multiple modules, such as redundant ESM 1210 for additional storage or combine three single phase inverters 1230 to produce a high wattage, 3-phase system with a 3-phase inverter 1235 as shown in FIG. 12, MES 1180h. Other systems, such those employing renewable energy sources, can also be utilized as shown in FIG. 13 as MES 1180i, wherein the PGM is realized as a solar inverter 1230 connected to a bank of photovoltaic cells 1202, as well as other forms including hydrogen fuel cells, thermoelectricity and thermos-acoustic conversion, which conform to the same module schema and construction with variations in internal hardware to accommodate the differences in technology.

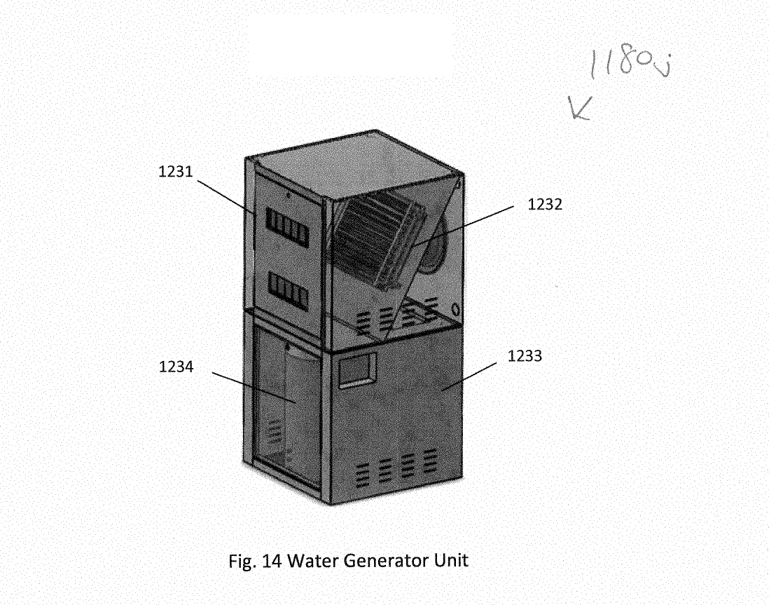

Aside from general energy production and processing, MES modules can also be made to incorporate a number of materials handling services. As shown in FIG. 14, MES 1180j can include a water generation system constructed using a condenser module 1231 with fan and condenser coils 1232 and a storage module 1233 with a pump and condensate storage container 1234. Alternatively, heat from the PGM can be used to vaporize water from liquid waste for recovery as condensate in a wastewater distillation system using a similar configuration. The system not only reclaims water for general use, but also lessens the overall waste mass. Lastly, environmental modules can also be constructed which use PGM exhaust heat to synthesize gas and trap carbon from hydrocarbon feedstock such as biomass. The former employs a module containing a steam boiler in a gasification process to generate synthetic fuels providing a zero carbon footprint process to extract useable fuel from waste biomass and plastics. This can be further improved by employing the latter, which can also be added as a module sub-system to capture flue gas CO2 producing a power generating waste to energy system with negative carbon emissions.

Thus, by utilizing a set of the modules along with a standardized design schema affording flexible and efficient integration, energy handling and energy process handling systems can be readily configured and assembled to produce a wide array of energy solutions. These range from simple battery backup for grid powered electrical systems to fully self-contained renewable and nonrenewable fuel powered electricity and HVAC systems with efficient biomass processing. The systems are not only highly adaptable to varying energy profiles and installation topologies, but are also highly efficient in almost every sense by reducing material and fabrication wastes, increasing overall energy efficiencies compared to conventional systems by reducing or eliminating distribution losses and improve yield by utilizing multiple conversion strategies which can include the processing of bio-waste.

Configuration and Reconfiguration

The modular configuration of MES 1180 from modules 1100 allows for MES 1180 to be initially configured into any one of a varied array of topologies by arranging and modularly coupling modules 1100, and by correspondingly operationally coupling the energy handling equipment contained within modules 1100. As such, MES 1180 may be modularly constructed into a variety of different geometric configurations. For example, with further reference to FIG. 10, PGM 1200 having a natural gas generator 1320 is shown operationally coupled to multiple STMs 1240a-1240d. Such operative coupling may be achieved using flexible operational coupling and/or communication architecture, such as flexible couplings, cables (electrical cable 1350), wires (communication busses 1340), flexible conduits (engine exhaust 1312), and tubing, and/or other flexible conduits for providing fluid, electrical, and/or data communication between energy process handling units (e.g., natural gas generator 1230) in one module with energy process handling units (e.g., STMs 1240) in one or more adjacent modules. In some embodiments, such flexible couplings couple with corresponding flexible couplings within the adjacent module(s). Such flexible couplings may have a length and/or flexibility sufficient to couple with an energy process handling component in any of the adjacent modules. For example, MES 1180e is shown in a first modular arrangement in FIG. 10, in which flexible couplings, electrical cables 1350, are in electrical communication between natural gas generator 1230 and STM 1240c on a backside of PGM 1200. However, MES 1180e may be reconfigurable into other modular arrangements. For example, in a second modular arrangement, the positions of STM 1240b and STM 1240c could be switched relative to their respective positions as shown in the first modular arrangement of FIG. 10. In such an embodiment, electrical cables 1350 may be rerouted from communication through portals 1140 that communicate through the backside of PGM 1200 to communication through portals 1140 that communicate through the topside of PGM 1200, with STM 1240c rearranged to reside on the topside of PGM 1200. Also, in such an embodiment, wires of communication bus 1340 may be rerouted from communication through portals 1140 that communicate through the topside of PGM 1200 to communication through portals 1140 that communicate through the backside of PGM 1200, with STM 1240b rearranged to reside on the backside of PGM 1200. Similarly, any necessary rerouting of flexible coupling may be performed to accommodate rearrangement of MES 1180 into any number of possible modular arrangements. Additionally, the internal cavity or space 1113 within each module, as shown in FIG. 7A, may accommodate such rerouting of flexible couplings. For example, internal cavity or space 1113 may be sufficient to contain the respective energy process handling component therein, while also including additional space, beyond the volume of the respective energy process handling component, that is sufficient to allow for flexible couplings to pass from a point of connection with the energy process handling component (input) to at least one of, and optionally any of, the access portals 1140 of module.

In further embodiments, panels 1120 are modular and operational interfaces equipped with access portals 1140 of suitable number, size, and/or positioning on panels 1120, such that panels 1120 are suitable for use with a variety of different energy process handling components. For example, a particular panel 1120 may be suitable for use with a particular energy process handling component if the access portals 1140 of that panel 1120 are positioned on the panel 1120 at suitable locations, and are of sufficient number and size, to allow for electronic, fluid, mechanical, and/or data communication from that energy handling component to energy process handling devices in adjacent modules. In some embodiments, panels 1120 on module 1100 may be rearranged thereon or replaced with other panels 1120, such that module 1100 may be configured with panels 1120 suitable for use with the particular energy process handling component contained in module 1100. For example, some panels 1120 may be configured for allowing operative communication between an ICE and a heat exchanger, such as via the number, size, and/or position of access portals 1140 thereon.

In certain embodiments, each energy process handling unit has at least one input, at least one output, or combinations thereof. For example, with further reference to FIG. 10, natural gas generator 1320 is shown as including exhaust output 1321 coupled to three engine exhausts 1312, and an electrical output 1351 coupled to three electrical cable outputs 1350. Natural gas generator 1320 may also include an input, such as a natural gas pipeline input (not shown). In some embodiments, natural gas generator 1320 may be rearranged, flipped, turned, twisted, rotated, or otherwise reoriented within the module such that the inputs and/or outputs of natural gas generator 1320 are oriented in a desired direction. Such reorientation of natural gas generator 1320 may accommodate the rearrangement of MES 1180e into different module arrangements. While discussed with respect to a natural gas generator 1320, said inputs, outputs, and rearrangements thereof by reorienting the respective energy process handling component is applicable to all energy process handling components disclosed herein.

The inputs and outputs discussed herein may have process directionality. For example, as shown in FIG. 10, exhaust from natural gas generator 1320 flows to the left of PGM 1200 towards STM 1240a, to the top of PGM 1200 towards STM 1240b, and to the back of PGM 1200 towards STM 1240c. However, MES 1180e may be rearranged such that at least some of exhaust from natural gas generator 1320 flows to the right of PGM 1200 towards STM 1240d. While discussed with respect to exhausts of a natural gas generator 1320, the discussed directionality is applicable to all inputs and outputs disclosed herein (e.g., electrical, data, mechanical), and may be changed in the same manner by reorienting the respective energy process handling component within the modules and/or by rearranging the modules into different module arrangements. The directionality of the inputs and/or outputs disclosed herein may provide energy process flow within the MESs 1180 disclosed herein with a directionality.

Rearrangement of modules and/or reorientation of energy process handling components contained therein allows modification of MESs 1180 disclosed herein. In some embodiments, modules may be arranged into geometrically distinct yet functionally equivalent MESs 1180 (e.g., in terms of advancing the same energy process flow). For example, MES 1180c, as shown in FIG. 8C may be suitable for use in a first application in which a vertically stacked modular arrangement is applicable, such as due to spatial requirements and/or restrictions of the first application. For use in a second application, MES 1180c may be rearranged into a side-by-side and/or linear arrangement, as shown in FIG. 8D, as MES 1180d. MES 1180d may be suitable for applications in which such a side-by-side and/or linear arrangement is applicable, such as due to spatial requirements and/or restrictions of the second application. As such, the same MES 1180 may be reconfigured into multiple different modular arrangements, for example MES 1180c and MES 1180d, to accommodate different applications. While such rearrangement has been discussed with reference to FIGS. 8C and 8D, the same rearrangements may be applied to any embodiments of MES disclosed herein. When rearrangement of MES 1180c into MES 1180d, any one or more of the rearrangement techniques discussed herein may be used, such as those discussed above with reference to FIG. 10, including, but not limited to, rerouting of flexible couplings, rearrangement of modules, and/or reorientation of energy process handling components contained within said modules.

Furthermore, the MESs 1180 disclosed herein may be modified to add modules thereto and/or subtract modules therefrom. For example, with reference to FIGS. 8A and 8B, a two-unit system, MES 1180a, containing a PGM 1200, such as a natural gas powered generator, and a control module 1230 may be constructed and used for a first application, such as providing electrical energy from a natural gas supply. For some applications, it may be desirable to add one or more functionalities to MES 1180a. For example, in embodiments in which MES 1180a contains a PGM 1200 including a natural gas powered generator and a control module 1230, it may be desirable to add a third module that provides, for example, energy storage functionality. As shown in FIG. 8B, the two-unit system of FIG. 8A may be converted into a three-unit energy process handling system, MES 1180b. For example, an ESM 1210 may be operationally coupled between PGM 1200 and control module 1230 for energy storage of system-generated electricity, and to supply and/or supplement electricity at pre-determined critical states, such as when the PGM 1200 is inoperable. However, in other embodiments, it may be desirable to subtract one or more modules and/or functionalities from MESs 1180 disclosed herein. Subtraction of modules and/or functionalities may be performed for any number of reasons including, but not limited to, reduction in costs (e.g., operational costs), temporary maintenance and/or repair of one or more modules or components, or spatial requirements and/or restrictions associated with a particular application. For example, in embodiments in which MES 1180b contains a PGM 1200 including a natural gas powered generator, a control module 1230, and ESM 1210, it may be desirable to remove ESM 1210, such as to satisfy spatial requirements. As shown in FIG. 8A, the three-unit system of FIG. 8B may be converted into a two-unit energy process handling system, MES 1180a. For example, ESM 1210 may be operationally de-coupled from PGM 1200 and control module 1230, and PGM 1200 and control module 1230 may then be operationally coupled together. While descried with respect to the embodiments shown in FIGS. 8A and 8B, the above discussed addition and subtraction of modules and/or functionalities may be applied to any of the MESs 1180 disclosed herein. As such, MES 1180 disclosed herein allow for addition and/or subtraction of modules and/or functionalities to accommodate varied and/or changing energy functionality, to scale components, to accommodate varied energy demands, or other application specific accommodations. Such accommodations are, at least in part, made possible using the modular architecture the modules 1100 disclosed herein, which allow for modular arrangement and coupling between multiple modules 1100.

Using the configuration and reconfiguration methods described herein, the modular configuration of MES 1180, from modules 1100, allows for MES 1180 to be initially configured into any of a varied array of topologies by arranging and modularly coupling modules 1100, and by correspondingly operationally coupling the energy process handling equipment contained within modules 1100. From said initial configuration, MES 1180 may be subsequently rearranged, reoriented, added to, and/or subtracted from, as discussed herein, to have a subsequent configuration (e.g., modular arrangement).

As such, through use of the configuration and reconfiguration methods described herein, MES 1180 assemblies are possible to accommodate other or new functionalities, applications, technologies, and/or energy sources. Such configuration and reconfiguration methods allow for construction of new architectures, supplementing of existing modular MES 1180 architectures, upgrading of existing modular MES 1180 architectures, and/or downgrading of existing modular MES 1180 architectures by module replacement, rearrangement, reorientation, and/or annexation. Such modular constructability may be, at least in part, accommodated by the use of interfaces (panels 11200 with registration structure (registration pins 1150), or other registration pins provided by interfacing structures strategically placed and sized for mating with corresponding registration architecture on corresponding, on modules 1100, as shown in FIG. 7A. While shown as having registration pins 1150 on top panel 1120, module 1100 may include registration pins 1150 on any or all sides (faces) of module 1100. As such, each side (face) of module 1100 may be selectively coupled with any side (face) of another, adjacent module. A particular module 1100 may be coupled with only a single additional module on a single side (face) of that particular modular; or may be coupled with multiple modules such that each face of the particular modular is coupled with an additional module; or may be coupled with more than one module such that multiple, but not all, sides (faces) of the particular modular are coupled with an additional module.

Embodiments of the MES 1180 disclosed herein may include one or more of the following architectures that accommodate configurable and reconfigurable modularity thereof:
a. Re-routable flexible couplings that allow for selective operational coupling between energy process handling components located in adjacent modules;
b. Access portals (e.g., 1140) on one, more than one, or all sides (faces) of modules that allow for electronic, fluid, mechanical, and/or data communication between energy process handling components of adjacent modules;
c. Panels (e.g., 1120) that are rearrangeable and/or reorientable and/or replaceable on sides of modules to allow for electronic, fluid, mechanical, and/or data communication between energy process handling components of adjacent modules;
d. Internal cavity or space within each module of sufficient volume and/or shape to accommodate the re-routing of flexible couplings and/or the reorientation of energy process handling components contained within the modules;
e. Reorientable energy process handling components that may be rearranged, flipped, turned, twisted, rotated, or otherwise reoriented within the module such that the inputs and/or outputs thereof are oriented in a desired direction;
f. The ability to selectively rearrange modules of MES into various geometric configurations (e.g., vertical stacked, horizontal linear or side-by-side);
g. The ability to selectively add modules to the MES;
h. The ability to selectively subtract modules from the MES; and
i. The selective, modular coupling between adjacent modules, such as through the use of panels with registration structure (e.g., pins) and corresponding registration structure (e.g., recesses and/or pin holes).

As such, embodiments of MES 1180 are characterized by interchangeability multi-positionability, such that one or more energy process handling units may be disassembled from MES 1180 and assembled/re-assembled in different relative positions, while maintaining relative direct operability. As discussed previously, such units or systems composed of such units are described as having modularity with flexible or variable inert-operability.

Installations and/or Applications of MES

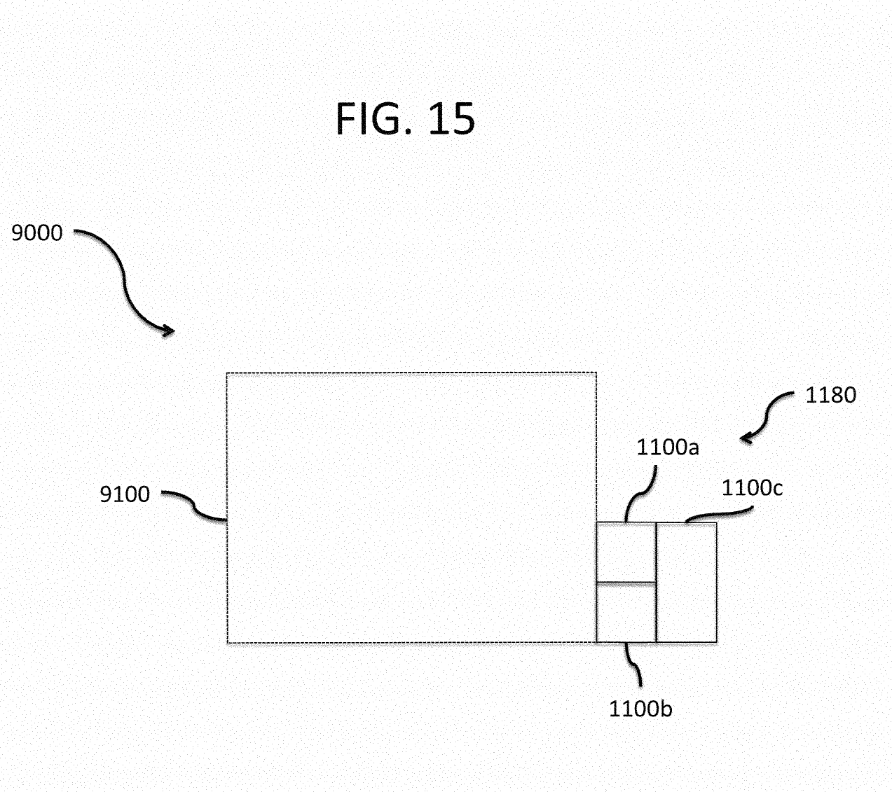

With reference to FIG. 15, system 9000 may include MES 1180 installed on or at facility 9100. MES 1180 includes a plurality of modules 1100a-1100c mutually, modularly engaged (e.g., coupled together) and operationally engaged, with each module directly modularly and operationally engaged with at least one other module. As described elsewhere herein, the system may contain one or more modules that are energy process handling units, preferably including at least one power generating or power handling unit (e.g., an internal combustion engine and\or a generator coupled with the engine in an adjacent module). In the exemplary embodiment of FIG. 15, an IC engine contained in module 1100a may be operationally coupled to the power handling component, a generator, contained win module 1100b. Facility 9100 may be a residential building, such as a house or apartment complex, or a commercial facility, such as an office building. However, facility 9100 is not limited to being a residential or commercial facility. MES 1180 may be adapted for any number of energy management tasks including generation, conversion, and storage and control. While MES in FIG. 15 is shown as including only three modules 1100a-1100c, MES may include more or less than three modules, modularly coupled together as described elsewhere herein. For example, and without limitation, MES may include one or more of a PGM, an STM, an ESM, an ETM, and an SCM. In some embodiments, the MES 1180 shown in FIG. 15 may be any of the MESs disclosed herein, such as any of MES 1180a-1180j. In some embodiments, MES 1180 in FIG. 15 is: a thermal system that includes an STM, ESM, ETM and SCM designed to provide grid and battery powered backup of a heat pump system of facility 9100; or an electrical system that includes a PGM, ETM and SCM designed to provide electrical energy to facility 9100 from both the electrical grid and natural gas supply; or a solar thermal system the includes an STM, ESM, ETM designed to accept communal electrical grid power and/or input from an array of solar panels, and SCM designed to provide grid and battery powered backup of a heat pump system (solar powered heat pump) of facility 9100; or a solar electrical system that includes a PGM, ETM that contains an inverter for accepting input from an array of solar panels for generating electricity, and SCM designed to provide electrical energy to facility 9100 from both the electrical grid and natural gas supply; or a dehumidifier system that includes either a PGM or an ETM, STM and SCM; or a water generation system that includes either a PGM or an ETM, STM and SCM, wherein condensed water vapor is stored for later use; or a waste water purification system that includes either a PGM or an ETM, STM and SCM; or a synthetic gas generation system that includes a PGM or an ETM, STM and SCM. In some embodiments, MES 1180 in FIG. 15 includes: a PGM, such as a natural gas powered generator, and a control module for providing electrical energy from a natural gas supply to facility 9100; or a PGM, control module, and an ESM configured for energy storage to supply and/or supplement electricity to facility 9100 at pre-determined critical states; or a PGM, control module, an ESM, and STM to supply and/or supplement electricity to facility 9100 and to provide heat pump service to facility 9100 using engine exhaust heat from the PGM; or a PGM, STM, ESM, and SCM as a heat and power system of facility 9100; or a natural gas based electrical generation system with a furnace, a bidirectional inverter for sourcing and sinking a communal electrical grid system, and a battery backup supply; or a solar inverter connected to a bank of photovoltaic cells; or a water generation system constructed using a condenser module with fan and condenser coils and a storage module with a pump and condensate storage container.

In some embodiments, one or more of the systems and/or components thereof, as shown and described with respect to FIGS. 1A, 1B, 2, 5A-5C, and 6, may be modularized in accordance with this disclosure, such as by containing one or more said components within the modules 1100 described herein. For example system 9000 may be a modular electric and internal combustion engine driven HVAC system suitable for incorporation with APU; or a combined cooling, heating, and power system, such as that employed in stationary applications for residential housing or commercial office buildings (e.g., an MCCHP system).

System 9000 may be a modularized embodiment of system installation 100 for generating and distributing power in a localized environment, as shown in FIG. 1A. In such a modularized system installation 100, one or more of the components of system installation 100 may be contained in modules 1100a-1100c, as shown and describe in FIG. 7A, and may be operationally coupled with other components of system installation 100. For example, internal combustion engine (ICE) and motor generator (MG) may each be contained in separate modules 1100a and 1100b, which may be modularly coupled together, with ICE and MG operationally coupled together. Such a system provides for a localized environment access to an energy source independent from the electrical grid by converting chemical energy into mechanical energy. Heat energy generated by operation of ICE may be transferred to facility 9100 (e.g., residence (R)) to satisfy energy demands, such as to heat or preheat water in an HVAC system, pool water, or a water heater, or heat air used for space heating.

In some embodiments, MES 1180 is or forms at least a portion of an HVAC system for facility 9100. For example, system 9000 may be a modularized embodiment of system installation 200, as shown in FIG. 1B for integrating a hybrid power generator with the energy demand loads of facility 9100, which may include a heating, ventilation, and air conditioning system (HVAC). In such embodiments, one or more of the components of system installation 200 may be contained in one or more modules 1100, and may be operationally and modularly coupled together. For example, in such a system, one or more of compressor 4, internal combustion engine 1, motor generator 3, DC regulator 8, DC bus 9, inverter charger 12, battery bank 11, and ECU 15 may be contained in modularly coupled modules 1100 and may be operationally coupled together (e.g., through access portals 1140) in the manner described with respect to FIG. 1B.

System 9000 may be a modularized embodiment of the system installation shown in FIG. 2. In such embodiments, one or more of the components of the system installation shown in FIG. 2 may be contained in one or more modules 1100, and may be operationally and modularly coupled together. For example, in such a system, one or more of engine 1, exhaust heat exchanger 217, process dehumidification unit 215, furnace or hot water heater 213, heat exchanger 217, and water circulation pump 221 may be contained in modularly coupled modules 1100 and may be operationally coupled together (e.g., through access portals 1140) in the manner described with respect to FIG. 2.

System 9000 may be a modularized embodiment of one of the system installations shown in FIG. 5A, 5B, or 5C. In such embodiments, one or more of the components of the system installation shown in FIGS. 5A-5C may be contained in one or more modules 1100, and may be operationally and modularly coupled together. For example, in such a system, one or more of battery bank, inverter charger, and DC generator may be contained in modularly coupled modules 1100 and may be operationally coupled together (e.g., through access portals 1140) in the manner described with respect to FIGS. 5A-5C. For example and without limitation, such a system may be used to provide hot water for a car wash, such as when facility 9100 is a gas station with a car wash, or to provide heat for a home, or to provide hot water for a swimming pool.

System 9000 may be a modularized embodiment of one of the system installations shown in FIG. 6. In such embodiments, one or more of the components of the system installation shown in FIG. 6 may be contained in one or more modules 1100, and may be operationally and modularly coupled together. For example, in such a system, one or more of water cooler condenser 606, compressor 604, refrigerator condensers 608,610, dryer 612, expansion valve 614, and evaporator 616 may be contained in modularly coupled modules 1100 and may be operationally coupled together (e.g., through access portals 1140) in the manner described with respect to FIG. 6.

System 9000 may be a modularized embodiment of one of the system shown in FIG. 9. In such embodiments, one or more of the components of the system installation shown in FIG. 6 may be contained in one or more modules 1100, and may be operationally and modularly coupled together. For example, in such a system, one or more of PGM 1200, STM 1240, ESM 1210, and SCM 1230 may be contained in modularly coupled modules 1100 and may be operationally coupled together (e.g., through access portals 1140) in the manner described with respect to FIG. 9. As previously explained, system 9000 may be a modularized embodiment of any system shown in FIGS. 1A-2, 5A-6, 7C, and 8A-14.

In certain embodiments in which one or more of energy process handling components produces heat, such as in the form of an exhaust fluid (liquid or gas), MES 1180 may include an STM. For example, some embodiments of MES 1180 include an ICE as an energy process handling component, which forms exhaust heat. In some such embodiments, an STM is contained in one module 1100 of the MES 1180, and an ICE is contained in another, adjacent module 1100 of MES 1180. The respective modules 1100 of the STM and ICE may be modularly coupled together in the manner described elsewhere herein. Further, the STM and ICE may be operationally coupled together; such as through access portals 1140 (e.g., via flexibly conduits). In such embodiments, exhaust heat from ICE may be communicated from the ICE to the STM for further processing. STM may be a system or apparatus adapted to process exhaust heat. For example, STM may use heat of said exhaust to heat liquids (e.g., water) or gases (e.g., ambient air). For example and without limitation, STM may include: a fan and cooling coils that use forced convection to remove water vapor from the surrounding air; or a boiler for vaporizing waste water and a condenser for collecting the produced water vapor. In some such embodiments, an MES 1180 including an STM may be used to provide heat to reclaim water from contaminated sources by producing distilled water and solid waste (e.g., a distillation system or unit). In other embodiments, an MES 1180 including an STM may be used provide heat to liberate gases (e.g., CO, CO₂ and/or H₂) from a feedstock, such as a hydrocarbon feedstock (e.g., biomass). In some such embodiments, STM may be used to provide heat pump service. In certain embodiments, STM includes a heat exchanger, such as a heat exchanger for ambient temperature control.

Embodiments that incorporate both a PGM and STM may synergistically harness greater amounts of useful energy, lower exhaust gas temperatures, and improve overall efficiencies as compared to that possible with single conversion systems (e.g., a PGM without an STM). Thus, embodiments having multiple energy conversion systems (e.g., PGM and STM) may provide energy in at least two different forms (e.g., electrical and thermal energy) to provide, for example, electricity to a residence or commercial facility while also providing heat to form hot water or heated air. In certain embodiments, an MES 1180 having multiple energy conversion systems may simultaneously provide energy in at least two different forms. Thus, energy may flow through MES 1180 along more than one path, and may exit MES 1180 via more than one output (e.g., via heat through coils of a heat exchanger and via electricity through switch 1390).

As described herein, MES 1180 may include multiple modular units that are inter-operationally and modularly engaged. MES 1180 may be a stand-alone system configured for localized (e.g., building) consumption and service. In some such embodiments, MES 1180 may have a power supply\outlet for receiving, for example, electricity or natural gas.

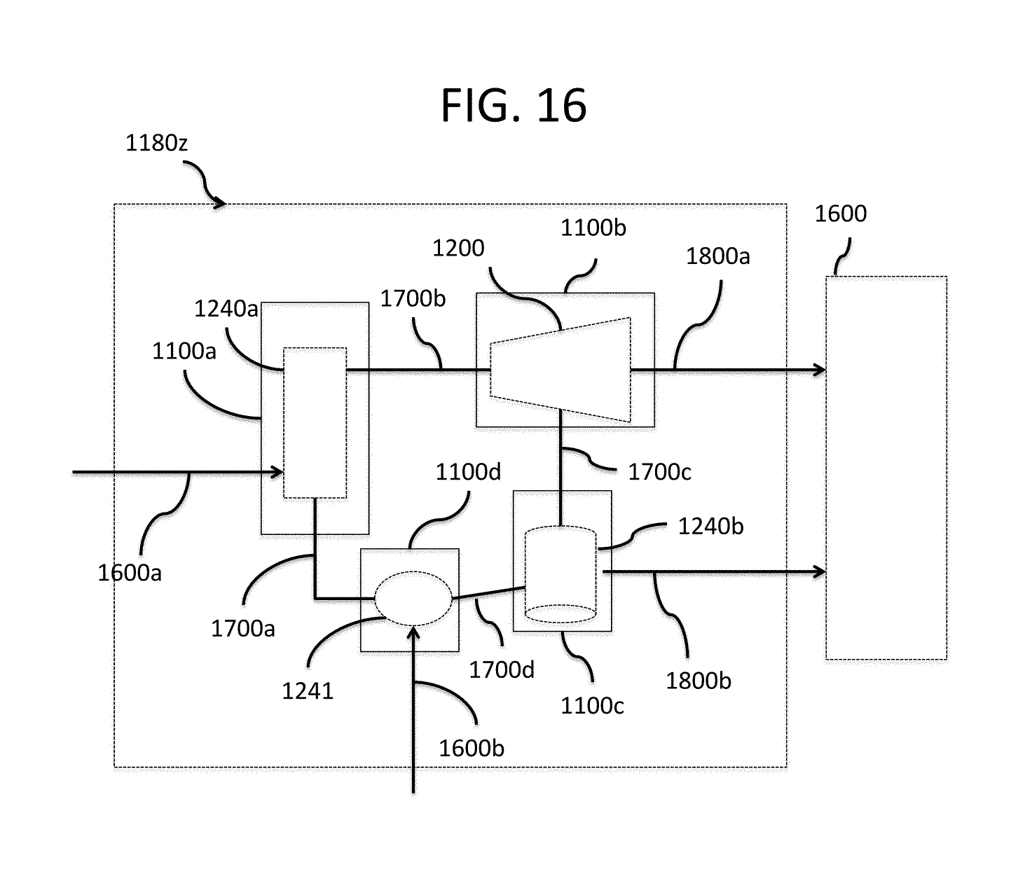

In some embodiments, MES 1180 includes one or more energy process handling modules that are modularly and operatively engaged, and adapted to process energy (system energy process) in a Rankine cycle. For example, FIG. 16 depicts an embodiment of MES 1180z configured to process energy in a Rankine cycle. While FIG. 16 depicts a particularly arrangement of particular energy process handling modules, MES 1180 may include other arrangements of the same or other energy process handling modules adapted to process energy in a Rankine cycle. MES 1180z includes energy process handling module 1100a, which may be an energy process handling modules adapted to receive a working fluid 1700a (e.g., water), and impart thermal energy to working fluid 1700a. For example and without limitation, energy process handling module 1100a may contain an STM 1240a (e.g., a boiler0. In some embodiments, energy (e.g., work) is input into energy process handling module 1100a to transfer thermal energy to working fluid 1700a via system energy inlet 1600a. For example, heat may be input via system energy inlet 1600a to energy process handling module 1100a (boiler) to boil working fluid 1700a, forming working fluid 1700b as a vapor (e.g., steam).

Working fluid 1700b may be transferred from module 1100a to energy process handling module 1100b. Modules 1100a and 1100b may be modularly coupled, operatively coupled, or combinations thereof. Module 1100b may be a power generation module, including a power generation unit 1200. For example and without limitation, module 1100b may include a turbine generator. Working fluid 1700b may enter module 1100b and expand therein, operatively driving the turbine generator, such that turbine generator generates energy as electricity. The electricity formed by the turbine generator may be a system energy process delivery outlet for delivery to a localized environment 1600. For example, the electricity formed by the turbine generator may provide electrical power to a residence or commercial building.

Module 1700b may be modularly coupled to energy process handling module 1100b, operatively coupled to energy process handling module 1100b, or combination thereof. Working fluid 1700c may exit module 1100b as a vapor (e.g., steam), liquid (e.g., water), or combinations thereof. Module 1100c may be a system thermal module 1240b. In some embodiments, module 1100c includes a condenser include. Within the condenser of module 1100c, thermal energy may be transferred from working fluid 1700c to an external medium, such as another working fluid or a heat sink. The external medium may exit the condenser of module 1100c as a second system energy process delivery outlet for delivery to the localized environment 1600. For example, the external medium may be heated water for use at a residence or commercial building.

Module 1700c may be modularly coupled to energy process handling module 1100d, operatively coupled to energy process handling module 1100d, or combination thereof. Working fluid 1700d may exit module 1100c as a condensate (e.g., water). Module 1100d may include a fluid pump 1241. In some embodiments, energy (e.g., work) is input into the pump 1241 of module 1100d (e.g., as electrical power) to operate the pump 1241, via system energy inlet 1600b. The working fluid may exit the pump 1241 of module 1100d as working fluid 1700a, which may by pumped to module 1100a, beginning the Rankine cycle again.

While MES 1180z is shown and described as including each of boiler, turbine generator, condenser, and pump as being contained within modules 1100, MES 1180 is not limited to this particular arrangement. One or more of boiler, turbine generator, condenser, or pump may be external of MES 1180z and not contained within a module 1100, as described herein. For example, in one embodiment, the boiler is external to MES 1180z and not contained within a module, thus eliminating module 1100a from the MES 1180z shown in FIG. 16. In such an embodiment, working fluid 1700b from the external boiler may be a system energy inlet to the MES, and working fluid 1700a exiting the pump of module 1100d may be a third system energy process delivery outlet for delivery to the boiler, which may be located in or near the localized environment.

The foregoing description has been presented for purposes of illustration and description of certain embodiments. This description is not intended to limit associated concepts to the various systems, apparatus, structures, and methods specifically described herein. For example, system and methods described in the context of a residence, may be applicable, in part or in entirety, to other permanent or stationary installations, such as commercial office building, factory, warehouse or other workplace, or such non-permanent but defined localized environments, as long-haul trucks or similar powered mobile vehicles. Although FIGS. 7-15 illustrate specific configurations and specific energy handling units, aspects of the systems, apparatus, processes, and methods described herein may be applicable or suitable in respect to other components (energy handling units or otherwise) and\or different mutual configurations not specifically illustrated or described herein. The embodiments described and illustrated herein are further intended to explain modes for practicing the system and methods, and to enable others skilled in the art to utilize same and other embodiments and with various modifications required by the particular applications or uses of the present embodiments.

1. An energy process handling system comprising:
energy process handling modules, each module being modularly and operationally engaged with at least one other of said modules, such that each module is inter-operationally engaged with each of said other modules; and
at least one system energy process delivery outlet to a localized environment and at least one system energy inlet.

2. The system of claim 1, wherein said modules include a power generating unit.

3. The system of claim 1, wherein each of said modules includes a plurality of faces with face dimensions that are multiple integers of face dimensions of a plurality of faces of said other modules.

4. The system of claim 1, wherein said energy process handling modules are configured for variable or flexibly operational inter-positionability, each said module including an energy process handling component and a frame supporting said component, said frame having multiple interfaces for accommodating coupling architecture directed from said energy process handling component externally of said frame for operational engagement with another of said modules.

5. The system of claim 1, wherein said energy process handling modules include at least a first energy process handling module coupled to at least a second energy process handling module, said system further including an energy process handling unit supported by one of said coupled modules and operationally engaged with another energy process handling unit supported by said other coupled module such that energy is transferable between said coupled modules.

6. The system of claim 5, wherein the first energy process handling module supports a power generating unit and the second energy process handling module supports an energy storage unit.

7. The system of claim 5, wherein the first energy process handling module supports a power generating unit and the second energy process handling module supports a thermal process unit operationally engaged with said power generating unit to receive exhaust heat therefrom for energy processing.

8. The system of claim 1, wherein each module comprises a frame and an internal cavity defined at least partially by the frame and supporting at least one energy process handling unit therein, and wherein each of said frames includes multiple interface panels each configured for modularly engaging one of a plurality of corresponding interface panels in one of said other modules of said system, each said interface panel being further configured to support communication architecture for energy process communication between said module partially defined by said frame and an energy process handling module modularly and operationally engaged therewith.

9. The system of claim 8, wherein each of said interface panels includes registration structure mateable with corresponding registration structure on said corresponding interface panels to align said modules for modular and operational engagement.

10. The system of claim 1, wherein said energy process handling modules include a power generation module; an energy storage module disposed, relative to said power generation module, to store energy transferred therefrom; and a third energy process handling module, wherein said modules are mutually modularly and operationally engaged to accommodate energy transfer between said three modules.

11. The system of claim 10, wherein said third module is a system thermal module disposed to process exhaust heat received from said power generation module, such that said three modules are mutually modularly and operationally engaged in first arrangement of modules to accommodate a system energy handling process; and
wherein, in said first arrangement, each of said three modules are detachably engaged, such that said modules are detachable from said first arrangement and re-engageable to define a second arrangement of modules accommodating the system energy handling process.

12. The system of claim 10, wherein said power generation module, said energy storage module, and said third energy process handling module are variably inter-positionable such that said modules are mutually registerable in a first modular arrangement to accommodate a system energy transfer process and mutually registerable in a second modular arrangement to accommodate the system energy transfer process.

13. The system of claim 12, further including an energy handling module in the form of a system control module disposed in communication with at least one of said other modules; and
wherein each of said modules is in modular engagement with at least one other of said modules.

14. The system of claim 1, wherein said energy process handling modules are mutually modularly and operationally engaged in first arrangement of modules to accommodate a system energy handling process, wherein the system energy handling process is a Rankine cycle.

15. The system of claim 14, wherein said energy process handling modules include a first system thermal module modularly and operationally engaged to a power generation module, the first system thermal module upstream of the power generation module; and a second system thermal module modularly and operationally engaged to the power generation module, the second system thermal module downstream of the power generation module, wherein the second system thermal module is in fluid communication with the first thermal module.

16. (canceled)

17. The system of claim 14, wherein said energy process handling modules include a boiler modularly and operationally engaged to turbine generator, a condenser modularly and operationally engaged to the turbine generator, and a pump modularly and operationally engaged to both the condenser and the boiler.

18. A method of operating a modular energy process handling system comprising:
modularly and operationally engaging at least three energy process handling modules in a first modular arrangement, wherein each said module is detachably engaged with at least one other of said modules, whereby each module supports an energy process handling component and disposes an interface panel in mutual correspondence with a corresponding interface panel of a modularly and operationally engaged adjacent module;
operating the modular energy system such that said modules accommodate a transfer of energy between said modules, whereby energy is directed between modularly and operationally engaged modules through mutually corresponding interface panels;
detaching one of said modules from adjacent modules and re-positioning said modules in mutual modular engagement to form a second modular arrangement, whereby each module supports an energy process handling component and disposes an interface panel in mutual correspondence with a corresponding interface panel of a modularly and operationally engaged adjacent module; and
operating the modular energy process handling system such that said modules accommodate a transfer of energy between said modules, whereby energy is directed between modularly and operationally engaged modules through mutually corresponding interface panels.

19. (canceled)

20. (canceled)

21. (canceled)

22. (canceled)

23. (canceled)

24. A method of assembling a modular energy process handling system comprising:
modularly and operationally engaging at least three energy process handling modules in a first modular arrangement wherein each said module is detachably engaged with at least one other modules, whereby each module supports an energy process handling component and disposes an interface panel in mutual correspondence with a corresponding interface panel of a modularly and operationally engaged adjacent module, said modular energy system being operable to accommodate a transfer of energy between modularly and operationally engaged modules through mutually corresponding interface panels; and
detaching one of said modules from modular and operational engagement with at least one adjacent modules, and re-positioning said modules in mutual modular and operational engagement to form a second modular arrangement, whereby each module supports an energy process handling component and disposes an interface panel in mutual correspondence with a corresponding interface panel of a modularly and operationally engaged adjacent module, said modular energy process handling system being operable to accommodate a transfer of energy between modularly and operationally engaged modules through mutually corresponding interface panels.

25. The method of claim 24, wherein said energy process handling modules include a power generation module; an energy storage module disposed, relative to said power generation module, to store energy transferred therefrom; and a third energy process handling module, wherein said modules are mutually modularly and operationally engaged to accommodate energy transfer between said three modules, and wherein said operating the modular energy system of the first modular arrangement effects generation of power and transfer of electricity from a generator of said power generation module to an electricity storage medium of the energy storage module.

26. The method of claim 25, wherein, in the second arrangement of modules, energy transferable through an energy transfer direction and a series of mutually corresponding interface panels is different from an energy transfer direction and series of mutually corresponding interface panels associated with the first arrangement of modules.

27. A system installation comprising:
an energy process handling system comprising multiple modules including at least a first energy process handling module modularly and operationally engaged with a second energy process handling module, wherein the modules are configured such that the modules may be removably coupled together into at least modular arrangements including a first arrangement of modules that accommodate an energy transfer process characterized by at least one process direction and second arrangement of modules that accommodate the same energy transfer process characterized by at least one different energy transfer process direction; and
a facility defining a localized environment, wherein said energy process handling system includes an energy process outlet in communication with the localized environment and delivering energy from said energy transfer process thereto.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)
